(19) United States
(12) Patent Application Publication
(10) Pub. No.: US 2014/0061537 A1
(43) Pub. Date: Mar. 6, 2014

(54) MULTI-DOPED LUTETIUM BASED OXYORTHOSILICATE SCINTILLATORS HAVING IMPROVED PHOTONIC PROPERTIES

(71) Applicant: Zecotek Imaging Systems Singapore Pte Ltd, (US)

(72) Inventors: Alexander Iosifovich Zagumennyi, Moscow (RU); Yuri Dmitrivech Zavartsev, Moscow (RU); Sergei Alexandrovich Kutovoi, Moscow (RU); Valentin Alekseevich Kozlov, Moscow (RU); Faouzi Abdelmounaime Zerrouk, Richmond (CA); Mikhail Vasilevich Zavertyaev, Moscow (RU)

(73) Assignee: Zecotek Imaging Systems Singapore Pte Ltd, Singapore (SG)

(21) Appl. No.: 13/861,971

(22) Filed: Apr. 12, 2013

Related U.S. Application Data
(60) Provisional application No. 61/624,227, filed on Apr. 13, 2012.

(51) Int. Cl. C09K 11/77

(52) U.S. Cl. CPC C09K 11/7795; C09K 11/7783; C09K 11/7792
USPC 252/301.6 F; 252/301.4 S; 252/301.4 P; 252/301.4 F; 423/263; 264/21

(57) ABSTRACT

The present invention relates to a set of multi-doped cerium-activated scintillation materials of the solid solutions on the basis of the rare earth silicate, comprising lutetium and having compositions represented by the chemical formulas: (Lu_{2-w-x+2y}A_{w}CeₓSi_{1-y})_{1-z}MeₓJⱼO_{q} and (Lu_{2-w-x-2y}A_{w}CeₓSi_{1+y})_{1-z}Me_{z}JⱼO_{q}. The invention is useful for detection of elementary particles and nuclei in high-energy physics, nuclear industry; medicine, Positron Emission Tomography (TOF PET and DOI PET scanners) and Single Photon Emission Computed Tomography (SPECT), Positron Emission Tomography with Magnetic Resonance imaging (PET/MR); X-ray computer fluorography; non-destructive testing of solid state structure, including airport security systems, the Gamma-ray systems for the inspection of trucks and cargo containers.

### CROSS-REFERENCE TO RELATED APPLICATIONS

This application claims the benefit of priority to U.S. Provisional Application No. 61/624,227 filed on Apr. 13, 2012, all of which application is incorporated herein by reference in its entirety for all purposes.

### TECHNICAL FIELD

The present invention relates generally to scintillation substances and, more particularly, to co-doped and multiple co-doped lutetium-based oxyorthosilicate scintillators (crystals and ceramics) having improved photonic properties such as, for example, improved radiation hardness. The present invention also includes related methods of making and using the scintillation substances disclosed herein.

### BACKGROUND OF THE INVENTION

It is known the scintillation substance/crystal of cerium doped lutetium oxyorthosilicate Ce₂ₓLu₂₍₁₋ₓ₎SiO₅, where x is varied between the limits from 2×10⁻⁴ to 3×10⁻² (U.S. Pat. No. 4,958,080, Sep. 18, 1990). The crystals of this composition are grown from a melt having composition of Ce₂Lu₂₍₁₋ₓ₎SiO₅. In scientific literature abbreviated name LSO:Ce is wide used for denotation of this crystal. The Ce₂₋ₓLu₂₍₁₋ₓ₎SiO₅ scintillation crystals have a number of advantages in comparison with other crystals: a high density, a high atomic number, relatively low refractive index, a high light yield, a short decay time of scintillation. The disadvantage of known scintillation material is the large spread of important characteristics of scintillation, namely, a light yield and an energy resolution, from crystal to crystal grown from a single boule. The experimental results of systematic measurements of commercially produced LSO:Ce crystals grown by CTI Inc. company (Knoxyille, USA), for example, display this (U.S. Pat. No. 6,413,311, Jul. 2, 2002).

The known method of crystal growing of the large size Ce-doped lutetium oxyorthosilicate, Ce:LSO, is described in the U.S. Pat. No. 6,413,311, where the Ce:LSO boules up to 60 mm in diameter and 20 cm long are grown by Czochralski technique. For growth of LSO crystals the silicon concentration Si_{1.00} has been used. An appreciable demerit of these large-sized Ce:LSO boules is that a light yield is strongly differed even within a boule, decreasing to 30%-40% from a top to a bottom of a boule. Furthermore, a scintillation decay time (a time of luminescence) may be varied over the wide range of values from 29 nanoseconds to 46 nanoseconds, at that an energy resolution value may fluctuate within the 12%-20% limit. Such a large spread in performance leads up to necessity during an industrial production to grow a large number of boules by Czochralski method, to cut them into parts (packs), to test each pack and on the basis of such tests to select the packs which possibly to utilize for fabrication of scintillation elements for medical tomographs.

Another confirmation of basic drawback of composition characterised by the silicon concentration Si_{1.00} (and oxygen O_{5.00}) are the examples described in U.S. Pat. No. 5,660,627. This patent discloses a method of growing of lutetium orthosilicate crystal with a plane front of crystallization by Czochralski method from a melt of Ce₂ₓLu₂₍₁₋ₓ₎SiO₅ chemical formula, where 2×10⁻⁴<x<6×10⁻². The pulse-height gamma spectrum from ¹³⁷Cs of LSO crystals grown with a conical front of crystallization and with a plane front of crystallization have the strong, fundamental differences both in a shape spectra and light output. For growth of LSO crystals are used expensive Lu₂O₃ with the chemical purity 99.99% or 99.998%, therefore the melt has not impurity ions. So the appreciable differences result from the composition of the initial melt, which has the silicon concentration Si_{1.00} and oxygen O_{5.00} and no impurity ions. A crystal growing from this melt has a composition differed from the composition of melt, the gradient of cerium ions concentration is observed along a crystal cross-section. The segregation coefficients of the host crystal components, lutetium (Lu), silicon (Si), oxygen (O) and cerium (Ce), are differed from unit, and, a crystal composition is shifting from melt composition. The problem is caused by the low distribution coefficient (k=0.22) of cerium. The concentration of cerium in growing Lu₂SiO₅ crystal is only 22% of cerium ions concentrations in melt. Additional problem is the charge cerium ions: Ce³⁺ in crystal and Ce⁴⁺ in the melt. In the U.S. Pat. No. 5,660,627 the crystals 26 mm in diameter were grown at the 0.5 mm/hour and 1 mm/hour rates, however, even at these very advantageous growth parameters, the crystals grown with a conical crystallization front cannot be used for the commercial applications because of low scintillation performance.

It is known the scintillation substance/crystals (variants) patented in the 2157552 patent, Russia, and the U.S. Pat. No. 6,278,832. Claim 2 teaches: Scintillating material based on a silicate crystal comprising lutetium (Lu) and cerium (Ce) characterised in that it contains oxygen vacancy at the quantity not exceeding 0.2 f.u. and its chemical composition is represented by the formula: Lu_{1-y}Me_{y}A₁₋ₓCeₓSiO_{5-□z} where A is Lu and at least one element selected from the group consisting of Gd, Sc, Y, La, Pr, Nd, Sm, Eu, Tb, Dy, Ho, Er, Tm, Yb, and where Me is at least one element selected from the group consisting of H, Li, Be, B, C, N, Na, Mg, Al, P, S, Cl, K, Ca, Ti, V, Cr, Mn, Fe, Co, Ni, Cu, Zn, Ga, Ge, As, Se, Rb, Sr, Zr, Nb, Mo, Ru, Rh, Pd, Ag, Cd, In, Sn, Sb, Cs, Ba, Hf, Ta, W, Re, Os, Ir, Pt, Au, Hg, Tl, Pb, Bi, U, Th, x is a value between 1×10⁻⁴ f.u. and 0.2 f.u., y is a value between 1×10⁻⁵ f.u. and 0.05 f.u., and z is a value between 1×10⁻⁵ f.u. and 0.2 f.u.

Partially the similar results are achieved in the U.S. Pat. No. 6,323,489. This patent discloses the lutetium-yttrium oxyorthosilicate crystal of composition having the chemical formula Ce_{z}Lu_{2-x-z}YₓSiO₅, where 0.05<x<1.95 and 0.001<z<0.02. The U.S. Pat. No. 6,624,420 and the U.S. Pat. No. 6,921,901 have the chemical formula Ce₂ₓ(Lu_{1-y}Y_{y})₂₍₁₋ₓ₎SiO₅, where 0.00001<x<0.05 and 0.0001<y<0.9999. The main disadvantage of the above mentioned inventions is the use only molar ratio equaled to 50% (Lu₂O₃+Y₂O₃+Ce₂O₃)/50% SiO₂=1 of starting oxides for all patented scintillation crystals, that corresponds exactly to stoichiometric composition of Lu₂SiO₅ structure. For all CeₓLu₁A₁₋ₓSiO₅ and Ce_{z}Lu_{2-x-z}YₓSiO₅ and Ce₂ₓ(Lu_{1-y}Y_{y})₂₍₁₋ₓ₎SiO₅ crystals the silicon concentration Si_{1.00} (oxygen O_{5.00}) and expensive Lu₂O₃ with the chemical purity 99.99% or 99.998% has been used. This composition does not allow to grow by Czochralski method the large commercial Ce-doped crystals having no radiation damage on all volume of crystal boule due to irradiation with gamma-rays/high energy protons. Another disadvantage of specified (Si_{1.00} and O_{5.00}) scintillation materials is inability produce PET scanner pixels having high light output with decay time in the range 15-30 ns.

Philips Medical Systems introduced a fully 3D TOF PET scanner from June 2006, using Ce:LYSO scintillator, having decay time 41 ns; the system timing resolution is about 400 ps. Now Siemens used Ce:LSO, having decay time 40-43 ns in all of their clinical PET scanners. The GE uses Ce:LYSO crystals in their research PET scanners.

First in world we reported about growth of large Ce³⁺:Lu₂SiO₅₋ₓ single crystals having oxygen vacancy after co-doping with Mg²⁺, or Ca²⁺ and we showed the improvement in light yield for calcium co-doped crystal relative to LSO:Ce and decreasing the decay time up to 32 ns after terbium ions co-doping [Yu. D. Zavartsev, S. A. Kutovoi, A. I. Zagumennyi “Chochralski growth and characterization of large Ce³⁺:Lu₂SiO₅ single crystals co-doped with Mg²⁺, or Ca²⁺, or Tb³⁺ for scintilation applications”. The 14 international conference on crystal growth (ICCG14), Edited 22 Jul. 2004, Grenoble, France, p. 564.], [Yu. D. Zavartsev, S. A. Koutovoi, A. I. Zagumenny “Czochralski growth and characterisation of large Ce³⁺:Lu₂SiO₅ single crystals co-doped with Mg²⁺ or Ca²⁺ or Tb³⁺ for scintillators” J. Crystal Growth, Vol. 275, Iss. 1-2, (2005) pp e2167-e2171].

The U.S. Pat. No. 7,651,632 discloses an inorganic scintillator material of a general formula Lu_{(2-y-x-z)}Y_{y}CeₓM_{z}Si₍₁₋ᵥ₎M′ᵥO₅ in which: M represents a divalent alkaline earth metal ion and M′ represents a trivalent metal. According to claim 1, the proportions of sum of silicon and trivalent metal ion, Si+M′, and oxygen to the remaining elements in the crystal remain constant equal five at all values of x, y, v and z. This limitation results in a violation of the law on preservation of charge neutrality, because the charge neutrality means that the total charge of positive ions must equal the total charge of negative ions in substance. For Lu_{(2-y-x-z)}Y_{y}CeₓM_{z}Si₍₁₋ᵥ₎O₅, put M is divalent ion Ca and v=0, then (2−y−x−z)·3(Lu³⁺)+y·3(Y³⁺)+x·3(Ce³⁺)+z·2(Ca²⁺)+1·4(Si⁴⁺)=6−3y−3x−3z+3y+3x+2z+4=10−z=[moles_of_oxygen]·2(O²⁻);

$$[ moles\_of \_oxygen ] = 5 - \frac{z}{2}$$

Because the moles of oxygen is calculated to be slightly less than 5 for all values of x and y, and z there must exist some value, z/2, of oxygen vacancies (□). After accounting for the oxygen vacancies, the resulting value of oxygen is 5−z/2. Thus, Claim 1 of the U.S. Pat. No. 7,651,632 recites inorganic scintillator materials of unrealizable compositions. In opposite the scintillating material having oxygen vacancy and the silicon concentration S_{1.00} and a divalent alkaline earth metal ion (including of Mg, Ca, Sr) and a trivalent metal ion (including of Al, In, Ga) it has already been disclosed and claimed in Claim 2 of U.S. Pat. No. 6,278,832 to Zagumennyi et al.

According U.S. Pat. No. 6,278,832[col. 8, ll. 20-25.] the lower limit for oxygen vacancy is equal to 1×10⁻⁵ f.units, which corresponds to the minimal concentration of heterovalent admixtures Me²⁺, the presence of which in a crystal of a scintillator causes the appearance of vacancies in an oxygen sub-lattice. It is mean that for Si_{1.00} and any concentrations of a divalent Me²⁺ alkaline earth metal ion (including of Mg²⁺, Ca²⁺, Sr²⁺) must exist the oxygen vacancy in chemical compositions of U.S. Pat. No. 7,651,632, U.S. Pat. No. 7,151,261, U.S. Pat. No. 8,034,258, U.S. Pat. No. 7,618,491, U.S. Pat. No. 7,749,323 and application for patent: (1) US 2006/0288926, Pub. Date: Dec. 28, 2006, (2) US 2007/0292330, Pub. Date: Dec. 20, 2007, (3) US 2008/0299027, Pub. Date: Dec. 4, 2008, (4) US 2006/0266276, Pub. Date: Nov. 30, 2006, (5) US 2010/0078595, Pub. Date: Apr. 1, 2010, these chemical compositions have already been disclosed and claimed in Claim 2 of U.S. Pat. No. 6,278,832 to Zagumennyi et al. It is known the rare-earth oxyorthosilicate scintillator crystals Lu_{2(1-x-y)}Ce₂ₓA_{2y}SiO₅, wherein A consists essentially of Ca, Mg, Sr, Zn or Cd or any combination thereof, the method comprising: selecting a fluorescence decay time about 30 ns and about 50 ns, inclusive, to be achieved for the grown single-crystalline material (U.S. Pat. No. 8,062,419, Date: Nov. 22, 2011, Assignee: Siemens Medical Solutions USA, Inc.). The chemical formulas in claims of rare-earth oxyorthosilicate scintillator Lu_{2(1-x-y)}Ce₂ₓA_{2y}SiO₅ teaches for an inorganic scintillator material of unrealizable compositions. According to claim 1-13, the proportions of sum of silicon and trivalent metal ions, divalent Ca, Mg, Sr, Zn Cd ions, and oxygen to the remaining elements in the crystal remain constant equal five at all values of x, y. This limitation results in a violation of the law on preservation of charge neutrality, because the charge neutrality means that the total charge of positive ions must equal the total charge of negative ions in substance—that is the fundamental law of the conservation of charge neutrality in a substance. It is clear that co-doping with divalent Ca, Mg, Sr, Zn Cd ions have the result of the oxygen vacancy and oxygen index are lower that 5.00 for silicon Si=1.00. This materials has already been disclosed and claimed in U.S. Pat. No. 6,278,832 to Zagumennyi et al. Additional Table 2 of U.S. Pat. No. 6,278,832 teaches that the calcium oxide (CaO) co-doped rare-earth oxyorthosilicate scintillator crystal demonstrated the high light output and decreased the decay time up to 32 ns in comparison with 42.3 ns of usual LSO crystal grown from the Lu_{1.98}Ce_{0.02}SiO₅ melt composition. On base of the range of decay time 32.1-44.1 ns and claimed composition in U.S. Pat. No. 6,278,832 there are not a novelty in U.S. Pat. No. 8,062,419 in comparison with U.S. Pat. No. 6,278,832 to Zagumennyi et al.

Melcher et al. checked the properties of calcium-cerium co-doped LSO crystal [M. A. Spurriera, P. Szupryczynskia, H. Rothfussa, K. Yanga, A. A. Carey, C. L. Melcher, “The effect of co-doping on the growth stability and scintillation properties of lutetium oxyorthosilicate”. Journal of Crystal Growth 310 (2008) 2110-2114] and he confirmed our first result disclosed in U.S. Pat. No. 6,278,832, that there are high light output and decreasing of decay time after calcium co-doping, relative to LSO:Ce with no co-doping. The decay time 36.7 ns and maximal light output 38,800 photons/MeV was measured for 0.1 at % Ca dopant concentration in comparison 30,900 photons/MeV of Ce:LSO, no co-dopant. The Ce:Ca:LSO crystals with higher Ca²⁺ concentrations demonstrated shorter decay time nd lower light output. For example, (LSO:Ce+0.2 at. % Ca) has decay time 33.3 ns in comparison 43 ns of LSO:Ce with no co-dopant.

It is known a method for enhancing the light yield of a single crystal of cerium doped lutetium orthosilicate (LSO, U.S. Pat. No. 7,151,261) and lutetium yttrium orthosilicate (LYSO, U.S. Pat. No. 7,166,845) after diffusing oxygen into the crystal by heating the crystal for a period of time in an ambient containing oxygen. This process of thermal oxygenation of the crystal effectively supplies oxygen to fill at least some of the oxygen vacancies in the body of monocrystalline LSO and LYSO, and it developed for scintillation detector comprises a monocrystalline body of LSO and LYSO enhanced by oxygen diffusion into the crystal. The diffusing results are increased performance based upon at least a 10% improvement in the energy resolution of the monocrystalline LSO and LYSO body. In this inventions need the additional annealing at 1100-1400° C. temperatures for the period of time in range of about 30 to 120 hours. The main disadvantage of the above mentioned inventions: for the growth of LSO and LYSO crystals the silicon concentration Si_{1.00} and expensive Lu₂O₃ with the chemical purity 99.99% or 99.998% has been used, in result it is the presence of oxygen vacancies. The second disadvantage is the two steps production technology. Firstly, the long-time growth process and long-time post-grown cooling of large boule. Secondly, long-time additional annealing process for oxygen diffusion into the crystalline LSO and LYSO having at least one dimension no greater than 20 mm. The given method can be utilised for improvement of parameters of thin 4×4×30 mm³ pixels for PET scanners, however this method does not allow reaching the homogeneous and constant scintillating parameters for large size pixels, because for high energy application in calorimeters optimal LYSO size is 25×25×280 mm.

The U.S. Pat. No. 7,297,954 teaches a inorganic scintillator has the chemical composition represented by CeₓLn_{y}Si_{z}Oᵤ, where Ln represent at least two elements selected from among Y, Gd and Lu. 0.001≦x≦0.1, 1.9≦y≦2.1, 0.9≦z≦1.1, 4.9≦x≦5.1, wherein the maximum peak wavelength in the intensity spectrum of emitted fluorescence is a peak in the range between 450 nm and 600 nm. The drawback of this composition characterised by maximum peak wavelength in the range between 450 nm and 600 nm. The Lu₂SiO₅ contains 64 ions in an elemental unit, in particular 8 ions of lutetium of the first type (Lu₁) and eight ions of lutetium of the second type (Lu₂). Different displacement of oxygen ions after the substitution of Ce³⁺ [symbol] Lu₁, Lu₂ in coordination polyhedron LuO₇ and LuO₆ determine principally different scintillation characteristics of the material. The light output, the position of the luminescence maximum and the constant of time for scintillations decay (time of luminescence) depend on the number of Ce³⁺, which substituted ions Lu₁ and/or ions Lu₂. So, in gamma excitation both centres of luminescence are always excited and luminescence simultaneously, and the constant of time for scintillations decay will depend both on the duration of luminescence of the first and second centres, and on the relationship of the concentration of ions of Ce³⁺ in coordination polyhedrons LuO₇ and LuO₆. The centre of luminescence Ce₁ (polyhedron LuO₇) has the time of luminescence of 30-38 ns and the position of the luminescence maximum 410-418 um. The centre of luminescence Ce₂ (polyhedron LuO₆) has the time of luminescence of about 50-60 ns and the position of maximum luminescence of 450-520 nm. The simultaneous presence of Ce³⁺ ions in LuO₇ and LuO₆ in a scintillation crystals have a negative result for scintillation parameters—the increasing of decay time longer than 50 ns and shifts the luminescence maximum into the area of 510 nm, which is the region of high photodiode conversion efficiency—it is an object invention of U.S. Pat. No. 7,297,954. But the new generation of Micro-pixeled avalanche photo diodes (MAPD) and SiPM diodes have high quantum efficiency for blue light at 405-420 nm, therefore the scintillation materials having position of maximum luminescence at 510 nm there are not optimal for MAPD. Additional technical drawback of U.S. Pat. No. 7,297,954 is the growing of crystals from melting compositions, containing expensive Lu₂O₃ with the chemical purity 99.99%.

Generalising the above-mentioned, we may conclude that a basic technical drawback, immanent to both the known scintillation crystals on the basis of lutetium orthosilicate, CeₓLu₂₋ₓSiO₅, and lutetium-yttrium orthosilicate, CeₓLu₁A₁₋ₓSiO₅, Ce_{z}Lu_{2-x-z}YₓSiO₅, Ce₂ₓ(Lu_{1-y}Y_{y})₂₍₁₋ₓ)SiO₅ crystals and a method of making of these crystals, are a longitudinal heterogeneity of optical quality of grown crystals, a heterogeneity of the basic scintillation parameters both in a bulk of boule grown by Czochralski method and heterogeneity from boule to boule grown in alike conditions and, at last, a low growth rate. A crystal growth from a stoichiometric composition leads up to that the segregation coefficients of the host crystal components, lutetium (Lu), yttrium (Y), oxygen (O) and the additional component, cerium (Ce), are differed from unit, and, a crystal composition is shifting from melt composition, that results in significant dispersions of light output of a luminescence and radiation hardness for top and bottom a crystal boule despite on the extremely low growth speed. A segregation coefficient of component is a ratio of component's quantity in a crystal to component's quantity in a melt.

We are the authors of known the scintillation substance (variants) disclosed in U.S. Pat. No. 7,132,060. This patent have defined the part of phase diagram for region of existence of lutetium oxyorthosilicate in the Lu₂O₃—SiO₂ system and disclose that exist the solid solutions of crystals having the variable index y for silicon concentration. The patented compositions described by the chemical formulae CeₓLu_{2+2y-x}Si_{1-y}O_{5+y}, CeₓLu_{2+2y-x-z}A_{z}Si_{1-y}O_{5+y}, and Li_{q}CeₓLu_{2+2y-x-z}A_{z}Si_{1-y}O_{5+y} where y varies between the limits from 0.024 f. units to 0.09 f. units, and where A is at least one element selected from the group consisting of Gd, Sc, Y, La, Eu, Tb, and Ca. In this invention are presented the methods used to make a scintillation substance in the form of powders, ceramics and single crystals. There are not the investigation of radiation resistance against gamma-rays and high energy protons/hadrons.

A technical drawback of known scintillating crystals is the growing of crystals from melting compositions, containing an expensive reagent Lu₂O₃ with the chemical purity 99.99% and 99.998%.

In [M. Kobayashi, M. Ishii, C. L. Melcher, “Radiation damage of cerium-doped lutetium oxyortosilicae single crystal”. Nucl. Instr. and Meth. A 335 (1993) 509-512.] measured radiation damage of high cerium doped (0.25% Ce³⁺) LSO crystal. Degradation of 0.25% Ce:LSO in optical transmission due to irradiation with ⁶⁰Co □γ-rays was about 2.5%/cm at 10⁷ rad, and 7%/cm at 10⁸ rad for the emission peak wavelength of 420 nm. The typical high-doped Ce:LSO crystals exhibit the main type of imperfection—the scattering center in middle and very strong in bottom parts of growing crystal boule. The problem of fine scattering is caused by the low distribution coefficient (k=0.22) of cerium. The concentration of cerium in growing Lu₂SiO₅ crystal is only 22% of cerium ions concentrations in melt. Therefore, it is not practical commercial production of high optical quality 0.25% Ce:LSO bars with size 25×25×280 mm³. Additional drawback of high cerium doped (0.25% Ce³⁺) LSO crystal characterised by the low energy resolution at height spectrum of a ³⁷Cs gamma-ray, the FWHM was 16% for the 662 keV.

Radiation resistance of non doped GSO and LSO crystals has been studied for 60Co gamma-ray by [P. Kozma, P. Kozma Jr. “Radiation sensitivity of GSO and LSO scintillation detectors”. Nucl. Instr. and Meth. A 539 (2005) 132-136.]. The relative degradation of GSO and LSO crystal transmission at wavelength of 420 nm for 10⁵ Gy (10⁷ rad) was found to be lower than 5.2%/cm and 5.0%/cm, respectively. The crystals growth conditions for investigated samples there are not published. From comparison of non doped LSO crystal and high cerium doped 0.25% Ce:LSO, it is clear, that 0.25 at. % cerium ions concentration improve about 2 times the radiation hardness of 0.25% Ce:LSO crystal in comparison with LSO, no co-dopant.

Radiation damage of thin samples of Ce:LSO produced by SICCAS (China) is studied by [Laishun Qin, Yu Pei, ShengLu, HuanyingLi, Zhiwen Yin, Guohao Ren, “A new radiation damage phenomenon of LSO:Ce scintillation crystal”, Nuclear Instruments and Methods in Physics Research A 545 (2005) 273-277]. Some of samples were strongly damaged near emission peak of LSO at low dose about 24 Krad.

We studied radiation hardness of LFS-3 crystal by comparing transmission spectra of the samples before and after irradiation using ⁶⁰Co source [V. A. KOZLOV, A. I. ZAGUMENNYI YU. D. ZAVARTSEV, M. V. ZAVERTYAEV, F. ZERROUK, “LFS-3-RADIATION HARD SCINTILLATOR FOR ELECTROMAGNETIC CALORIMETERS” EPRINT NUMBERS: ARXIV.0912.0366V, 2 Dec. 2009.]. In this publication there are not investigation about measured composition of a crystals having maximal or enhanced radiation hardness.

Comparison radiation hardness of large 2.5×2.5×20 cm³ commercial Ce-doped LYSO produced by (i) CPI Crystal Photonics, Inc. (CPI), (ii) Saint-Gobain Crystals (SG), (iii) Sichuan Institute of Piezoelectric and Acousto-optic Technology (SIPAT) are presented in [Ren-Yuan Zhu. “LYSO crystals for SLHC”. CMS ECAL Workshop at Fermilab, Nov. 20, 2008.]. For small 17 mm³ cubic LYSO (SIPAT) 24 samples the energy resolution in the range 9.8%-11.3% was measured. Degradation of LYSO (SIPAT) in optical transmission at 420 nm was 8% for 1.7 cm length (or 4.7%/cm) due to irradiation by gamma-rays at the dose 10⁶ rad. It is clear that degradation will be more significant after increasing the dose from 10⁶ rad to 10⁷ rad, and the more greatly at 108 rad dose. About 10-11% light output loss of LYSO from SG in comparison with about 15% light output loss of LYSO from CPI and SIPAT after 1Mrad irradiation dose by ²²Na gamma source were demonstrated. Ren-Yuan Zhu investigation shown that commercial LYSO crystal composition produced by SG, SIPAT, CPI have problem with radiation hardness, therefore the search of advanced chemical compositions with better radiation resistance it is very important now for replacement of tungsten PWO crystals in ALICE and CMS experiments at LHC (CERN, Switzerland).

In prior patents the high light output it is the highest priority of known scintillation crystals, because the application for Positron Emission Tomography (PET scanner) need to use the crystals with maximal light output for decreasing quantity of radioactive ions in the blood of patient. The crystals in PET scanner have not a request for stability parameters after gamma irradiation, because the emission of gamma-ray is very low from patient.

Accordingly, and although various co-doped lutetium-based oxyorthosilicate scintillation crystals are known to exist, there is still a need in the art for new and improved lutetium-based oxyorthosilicate scintillation crystals that have one or more enhanced photonic properties (such as, for example, resistance to radiation damage). The present invention fulfills these needs and provides for further related advantages.

### SUMMARY OF THE INVENTION

The invention is applied to scintillation crystals and may be used for detection of elementary particles and nuclei in high-energy physics, for registrations and measuring of x-ray, gamma- and alpha-radiation in nuclear industry; medicine, Positron Emission Tomography (PET) and Single Photon Emission Computed Tomography (SPECT), Positron Emission Tomography with Magnetic Resonance imaging (PET/MR); x-ray computer fluorography; non-destructive testing of solid state structure, including for high-dose x-ray applications with energies up to 160 keV in systems for low-density materials imaging in airport security systems, in systems for x-ray control of quality and in the gamma-ray systems, which it used a Cesium-137 or Cobalt-60 gamma source, for the inspection of trucks and cargo containers for concealed contraband, smuggled goods.

The invention is applied to scintillation crystals for positron emission tomography (PET), which utilizes a radioactive tracer to make images of the distribution of labelled molecules in vivo for different medical targets, for example, (1) the whole-body imaging during diagnostic at early stage cancer of a patient in hospitals, (2) the neuro-imaging of human brain. PET is a tool for metabolic imaging that has been utilized since the earliest days of nuclear medicine. An important component of such imaging systems are the detector modules on base of scintillation crystals. The decay time of commercial Ce:GSO, Ce:LSO, Ce:LYSO crystals are 65 ns, 40 ns and 41 ns, respectively. The high density, high light output and short decay time are very important parameters for PET application. The new generation medical PET scanners is a very active area of development two designs: (1) for ability to determine how deep in the crystal an event actually occurs (depth of interaction or DOI PET). Pulse shape discrimination based at depth-of-interaction detector designs. The concept is to use two or more layers of crystals that have different light decay times. (2) Other solution is time-of-flight (TOF PET).

For significant improvement both this solutions it need the advanced crystal materials with high density ˜6.8-7.4 g/cm³ and high light output about 60-95% of NaI(Tl) and one exponential decay constant in the range 12-38 ns for different composition. Additional these advanced crystal materials need maximum emission of light in the area 400-450 nm for maximal efficiency of new generation semiconductor sensor. A task of the given invention is a creation of new scintillation materials having such parameters.

Cerium doped lutetium-based oxyorthosilicate crystal growth is relatively expensive due to the cost of Lu₂O₃, having price from US $400/kg of purity 99.9% till US $1500/kg of high purity oxide 99.998%. The growth of one large boule with 90 mm in diameter there is need about 20 kg of Lu₂O₃. The cost of 99.99% Lu₂O₃ is approximately 70% of cost of crystal growth process. Decreasing the cost of one crystal growth process in 2 times and an increase of upper level of impurities ions in scintillated materials on base of low cost Lu₂O₃ is a purpose/an object of the given invention.

A task of the given invention is a creation of advanced scintillation material based on a silicate comprising a lutetium (Lu) and cerium (Ce) characterised in that the composition is represented by the chemical formulas:

(Lu_{2-w-x+2y}A_{w}CeₓSi_{1-y)}_{1-z}Me_{z}JⱼO_{q} (1)

and (Lu_{2-w-x-2y}A_{w}CeₓSi_{1+y})_{1-z}Me_{z}JⱼO_{q} (2)

and said scintillation material having the high density ˜6.8-7.4 g/cm³, the high light output about 60-95% of NaI(Tl), the one exponential decay constant in the range 12-38 ns for different compositions, the maximum emission of light in the area 400-450 nm, the energy resolution for the full energy peak in the range from 6% till 10%, the high radiation resistance against high energy protons/hadrons, no degradation in optical transmission after gamma-rays irradiation with the dose up to 23 Mrad.

The LFS is a brand name of the set of Ce-doped scintillation materials of the solid solutions on the basis of the rare earth silicate, comprising lutetium and having compositions represented by the chemical formulas:

(Lu_{2-w-x+2y}A_{w}CeₓSi_{1-y})_{1-z}Me_{z}JⱼO_{q} (1)

and (Lu_{2-w-x-2y}A_{w}CeₓSi_{1+y})_{1-z}Me_{z}JⱼO_{q} (2)

Both formulas (1) and (2) demonstrated that it is possible the solid solutions for cerium doped lutetium-based oxyorthosilicate scintillation materials. Solid solution is a powders/ceramics/crystals materials, having a defects in comparison with ideal crystal structure. In ideal structure the 100% of Lu³⁺ ions located in 100% position of Lu, the 100% of Si⁴⁺ ions located in 100% position of Si of ideal crystal structure, the 100% of oxygen O²⁻ ions located in 100% position of oxygen of ideal crystal structure. The distortion of the crystalline lattice and existence of point defects in the lattice, such as vacancies, interstitials, anti-sites, relative to its ideal configuration is what is generally meant as “defects”. In general, LFS are scintillation materials having defects in form of the vacancy/or interstitial for Lu ions, the interstitial/or vacancy for Si ions, the vacancy for oxygen ions. (See Examples of 1-7). An transformation of the chemical formula of LFS scintillation material into the equivalent chemical formula, having the identical mole ratios of components (Lu+Ce+A+Me)/Si and the identical percents of the oxides, is made by multiplying formula indexes in the formula (1) or (2) at the scaling coefficient.

The oxygen vacancies are recited to reflect an accurate value of oxygen in the final crystal solid-state composition. When the crystal forms, it must obey the conservation of charge neutrality laws, or, in other words, the total positive ions must equal the total negative ions.

The additional doping of cerium (IV) oxide, initially a Ce⁴⁺ ion, also substitutes in place of the lutetium ions. The placement of the reduced cerium ion (3⁺) in either the first lutetium's position (Lu1) or second lutetium's position (Lu2) partially determines the characteristics of the scintillator material (LFS, Ce:LSO, Ce:LYSO, Ce:LGSO), having a monoclinic structure with a space group of C2/c. The structure has two distinct rare earth cation sites. One is a distorted 7-fold coordinate site and the other one is a smaller distorted 6-fold coordinate site. These two sites are quite different from each other, with distinct energy levels for emission. When the crystal is doped with cerium, the dopant substitutes into both sites for LSO, LYSO, LGSO with distribution ratio of about 50:50 between the two sites. LFS disclosed herein are solid solution of materials having defects in the lattice and significant higher Ce³⁺ concentration in a distorted 7-fold coordinate site in comparison with 6-fold coordinate site.

During Czochralski growth process of LFS crystals there are created the defects: the vacancy/interstitial for Lu ions, the interstitial/vacancy for silicon ions and the oxygen vacancy in the moment solidification on the interface of melt/crystal. Additional oxygen vacancy, in same time on the interface of melt/crystal are created after replace of Lu³⁺ ions at mono/divalent ions (Ca²⁺, Mg²⁺, Li¹⁺). Both method formations of defects there are effective for improvement scintillation parameters of prior LFS compositions.

A technical task solved by the present invention is mass production of the large LFS crystalline boules grown from the melt for application in the new generation of electromagnetic calorimetry experiments in high energy physics for search and detection of new elementary particles and nuclei. The scintillation crystals for future collider detector should have the following priority of scintillation properties: (i) high density, (ii) not a radiation damage after irradiations by large doze of gamma-rays and protons, (iii) short decay time, (iv) good energy resolution, (v) homogeneity of scintillation properties at mass production of thousand bars with size up to 25×25×280 mm³ or at mass production of thousand active plates with size up to 25×25×5 mm³ of a “Shashlik”-type readout for the High-Luminosity Large Hardron Collider (HL-LHC) at CERN. The huge energy of particles emits many lights in scintillation crystals. The PbWO₄ (Y:PWO) have decay time 10 ns and light output only 0.3% light output of NaI(Tl), but PWO is presently used for world's larger calorimeter LHC (CERN, Switzerland). Therefore the light output it is not an important in comparison with the short decay time and stability parameters after large doze of gamma-rays/protons irradiation.

Radiation hardness of Lu-based scintillation crystals is important in many applications of radiation detectors. Currently there is a strong demand for ultra radiation resistant crystals for electromagnetic calorimeters located near beam-pipe, in the end-cap region, and capable of working under heavy condition during an extended length of time.

The given invention developed a production of grown by Czochralski methods large crystalline boules, having a high density, short decay time, good energy resolution and radiation resistance against irradiations by large doze of gamma-rays/protons/hadrons for application in high-energy physics.

An important technical task solved by the given invention is a production of large crystalline boules, having the good energy resolution and high light output of a luminescence over all volume, grown by Czochralski method for application in medicine, including of Time-Of-Flight Positron Emission Tomography (TOF PET), Depth Of Interaction or DOI PET, Single Photon Emission Computed Tomography (SPECT) and X-ray computer fluorography.

Additional technical result of this invention it is achieved by the use as a raw materials the Lu₂O₃ having the purity of 99.9% instead of Lu₂O₃ with a purity of 99.998% in the known patents. The low price Lu₂O₃ allows decreasing the cost of a melting raw materials about 2 times for grown LFS crystals. The impurities Sc, Y, La, Ce, Ca, Mg, Gd, Si ions found in the low price Lu₂O₃ have not a negative influence; therefore it is possible a high concentration of this ions in low cost Lu₂O₃. The price of Lu₂O₃ significant depended from concentration of rare earth ions: Pr, Nd, Sm, Eu, Tb, Dy, Ho, Er, Tm, Yb, because the chemical properties of rare earth ions are close to properties of lutetium ions, and this reason of many step cleaning procedures, which one determinate the high price of 99.998% purity Lu₂O₃ in comparison with 99.9% purity Lu₂O₃. In other hand Czochralski crystal growth process is a good cleaning procedure for different ions, for example, during growth process about 25% of cerium ions replace lutetium ions Lu₂SiO₅ crystal, but the other 75% cerium ions are stay in the melt. Analogy situation exist for many others impurity ions, in results a lutetium based crystals grown from a low price Lu₂O₃ have concentration impurity ions 2-5 times lower than concentration this ions into a raw material charge of a crucible. In the case of low price Lu₂O₃ a few impurities ions, for example, Ca²⁺ ions did significant improvement of scintillation and crystal growth parameters, but with very low calcium concentration impurity a 99.999% Lu₂O₃ has significant higher cost production. The optimisation maximal concentration for each impurity ions give possibility decrease the cost production of low cost Lu₂O₃, and from this lutetium oxide grown LFS crystals have the same or better high scintillation parameters like crystals grown from expensive high purity Lu₂O₃.

These and other aspects of the present invention will become more evident upon reference to the following detailed description and attached drawings. It is to be understood, however, that various changes, alterations, and substitutions may be made to the specific embodiments disclosed herein without departing from their essential spirit and scope.

### BRIEF DESCRIPTION OF THE DRAWINGS

Aspects of technical solutions proposed herein are illustrated, in part, by way of the following drawings.

FIG. 1 shows the emission spectra of a (Lu_{2-w-x+2y}A_{w}CeₓSi_{1-y})_{1-z}Me_{z}JⱼO_{q} scintillation material (the curve 1 having maximum at 431 nm) and a (Lu_{2-w-x-2y}A_{w}CeₓSi_{1+y})_{1-z}Me_{z}JⱼO_{q} scintillation material (the curve 2 having maximum at 450 nm) in accordance with an embodiment of the present invention. The emission spectra have been measured for X-ray excitation at temperature 300K.

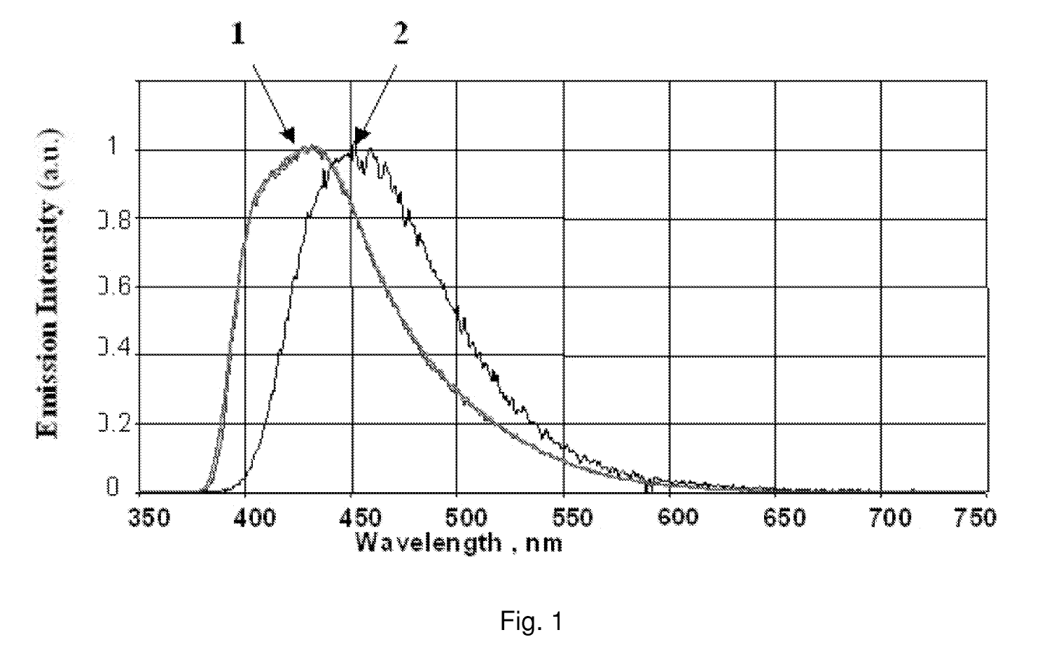

FIG. 2 shows transmission spectra of LFS-3 crystal before and at various intervals after proton irradiation (sample length is 20 mm) in accordance with an embodiment of the present invention.

### DETAILED DESCRIPTION OF THE INVENTION

We used the Czochralcki (CZ) and Kyropoulas methods for growth of different chemical compositions of LFS single crystals from inductively heated iridium crucibles having diameter from 40 mm till 150 mm. In crystal growth process the Y₂O₃, Gd₂O₃, CeO₂, SiO₂, CaO starting materials were 99.9% pure. The high price of 99.998%, 99.99% purity Lu₂O₃ and low price of 99.9% purity Lu₂O₃ were used. After long time cleaning procedure the iridium crucibles were used for each experimental growth of LFS boules having different chemical composition. A CZ growing of low and high Ce³⁺ doped LFS crystals was executed under a good thermal insulation conditions in a protective inert gas atmosphere (100% volume of nitrogen, weekly oxidising N₂ and argon, 100% volume of argon), at pulling rate of 0.9-3 mm h⁻¹, rotation rate of 3-35 r.p.m.

For control composition of crystal pixels for PET scanners and the samples for measurement of radiation hardness, the real concentration of matrix elements (Lu, Si, Ce, Y, Gd, Sc, La and others ions) by ICP-MS analysis and oxygen concentration by LECO analysis were measured. The impurities of all chemical elements in investigated crystals were analyzed by Glow Discharge Mass Spectroscopy (GDMS) analysis. The commercial electronic microanalysis device are used for investigation of composition grown crystals and the change of concentration of Lu, Si, Ce, Ca, Mg, Y, Gd, Sc matrix elements along of a crystal boule from top to bottom.

For light output and energy resolution, we excited of polished samples with 662 KeV gamma rays ¹³⁷Cs source located ˜15 mm from the crystal surface. The crystal sample was placed directly on the Hamamatsu R4125Q photomultiplier and covered with Teflon reflector and additionally with Al foil reflector. A fast amplifier ORTEC 579 and a charge-sensitive height converter ADC LeCroy 2249W were used. In order to extract the photoelectron yield and light output of scintillators, the position of the full energy peak from ¹³⁷Cs source was compared with that of the single photoelectron peak.

The decay times of light pulses from tested crystal samples were measured by “START-STOP” single photon method using a plastic scintillator as separate material to produce a reference signal. The results of the measurements are presented in TABLE 1.

The measurements of crystals density were carried out according to a standard procedure of hydrostatic weighing, this method is utilized in geology during ten-years. In these experiments we used the bulk polished samples weighing about 5-10 grams. The measurements were fulfilled in a distilled water preliminary boiled during 20 minutes to remove an oxygen and cooled to the room temperature. A temperature of water was being measured with an accuracy 0.1° C. To provide the minimal errors, each sample was weighed five times, in this case an error of determination of crystal samples density did not exceed 0.001 gram/cm³. The results of the measurements are presented in TABLE 1.

The emission spectra of Ce³⁺ ions have been measured for a X-ray excitation at temperature 300 K.

In view of the foregoing, various further aspects of the present invention are disclosed below by way of enumerated technical ASPECTS #1-#30.

Aspect #1.

In a first technical task of the given invention a new is a composition of advanced scintillation material having emission maximum in range 400-450 nm and base on a silicate comprising a lutetium (Lu) and cerium (Ce) characterised in that the composition is represented by the chemical formula:

(L_{2-w-x-2y}A_{w}CeₓSi_{1-y})₁₋ₓMe_{z}JⱼO_{q} (1)

where

A is at least one element selected from the group consisting of Sc, Y, Gd, and Lu;

Me is at least one element selected from the group consisting of Li, Na, K, Cu, Ag, Mg, Ca, Zn, Sr, Cd, B, Al, Ga, V, Cr, Mn, Fe, Co, Ni, Ti, Ge, Zr, Sn, Hf, La, Pr, Nd, Sm, Eu, Tb, Dy, Ho, Er, Tm, Yb, and Lu;

J is at least one element selected from the group consisting of N, F, P, S, and Cl;

q is a value between 4.9 f.u. and 5.024 f.u.,

w is a value between near 0 f.u. and 1f.u.,

x is a value between 3×10⁻⁴ f.u. and 0.02 f.u.,

y is a value between 0.003 f.u. and 0.024 f.u.,
z is a value between near 0 f.u. and 0.001 f.u.

j is a value between near 0 f.u. and 0.03 f.u.,

The lower limit of w, z, j is determined the compositions in which it is not practical to measured concentration this ions by ICP-MS, GDMS analysis. The upper limit z, j is designed by the maximum concentration of these elements content in scintillation material. When their content is above the indicated limit, the destruction of the structural type Lu₂SiO₅ takes place and the formation of a few micron size inclusions of other phases, which determine very strong scattering of light and the decrease of transparency of a scintillating crystal. For the upper limit w is put from the fact that, at higher ions concentrations than the limit, in result this low-density crystal materials have not a perspective for application in PET scanners and high-energy physics.

The lower limit x is determined from experimental results, at Ce ions concentrations lower than this limit, it is not practical produce a material with high light output for application in PET scanners. The upper limit x is assign by the Czochralski growth, because at Ce ions concentrations higher than this limit, it is not practical produce a large commercial crystal boules using 50% of melt.

The lower and upper limit y are defined by different chemical compositions of the advanced scintillation ceramic, by the compositions of melt for growth of scintillation crystals, by the investigation composition of grown crystals.

The lower and upper limit q are depended: (a) from concentration matrixes and impurities ions, according of the law on preservation of charge neutrality, because the charge neutrality means that the total charge of positive ions must equal the total charge of negative ions in scintillation substance; (b) an transformation of the chemical formula (1) of scintillation material into the equivalent chemical formula, having the identical mole ratios of components (Lu+Ce+A+Me)/Si and the identical percents of the oxides.

In a second task of the given invention a new is a composition of advanced scintillation materials having emission maximum in range 400-450 nm and base on a silicate comprising a lutetium (Lu) and cerium (Ce) characterised in that the composition is represented by the chemical formula:

(Lu_{2-w-x-2y}A_{w}CeₓSi_{1+y})_{1-z}Me_{z}JⱼO_{q} (2)

where

A is at least one element selected from the group consisting of Sc, Y, Gd, and Lu;

Me is at least one element selected from the group consisting of Li, Na, K, Cu, Ag, Mg, Ca, Zn, Sr, Cd, B, Al, Ga, V, Cr, Mn, Fe, Co, Ni, Ti, Ge, Zr, Sn, Hf, La, Pr, Nd, Sm, Eu, Tb, Dy, Ho, Er, Tm, Yb, and Lu;

J is at least one element selected from the group consisting of N, F, P, S, and Cl;

q is a value between 4.9 f.u. and 5.0 f.u.,

w is a value between 0 f.u. and 1f.u.,

x is a value between 3×10⁻⁴ f.u. and 0.02 f.u.,

y is a value between 0.001f.u. and 0.04 f.u.,

z is a value between 0 f.u. and 0.001 f.u.,

j is a value between 0 f.u. and 0.03 f.u.,

The lower limit of w, z, j is determined the compositions in which it is not practical to measured concentration this ions by ICP-MS, GDMS analysis. The upper limit z, j is designed by the maximum concentration of these elements content in scintillation materials. When their content is above the indicated limit, the destruction of the structural type Lu₂SiO₅ takes place and the formation of inclusions of other phases, which determine very strong scattering of light and the decrease of transparency of a scintillating crystal. For the upper limit w is put from the fact that, at higher ions concentrations than the limit, in results this low-density crystal materials have not a perspective for application in PET scanners and high-energy physics.

The lower limit x is determined from experimental results, at Ce ions concentrations lower than this limit, it is not possible produce a material with high light output for application in PET scanners. The upper limit x is assign by the Czochralski growth, because at Ce ions concentrations higher than this limit, it is not possible produce a large commercial crystal boules using 50% of melt.

The lower and upper limit y are defined by different chemical compositions of the advanced scintillation ceramic, by the compositions of melt for growth of scintillation crystals, by the investigation composition of grown crystals.

The lower and upper limit q are depended: (a) from concentration matrixes and impurities ions, according of the law on preservation of charge neutrality, because the charge neutrality means that the total charge of positive ions must equal the total charge of negative ions in scintillation substance; (b) An transformation of the chemical formula (2) of scintillation material into the equivalent chemical formula, having the identical mole ratios of components (Lu+Ce+A+Me)/Si and the identical percents of the oxides.

A third task of the given invention is a creation of advanced (Lu_{2-w-x+2y}A_{w}CeₓSi_{1-y})_{1-z}Me_{z}JⱼO_{q} scintillation materials having the silicon concentration from Si_{0.997} till Si_{0.976} and the mole ratios of components (Lu_{2-w-x+2y}+Ceₓ+A)/Si_{1-y}>2; the high density ˜6.8-7.4 g/cm³, the high light output about 60-95% of NaI(Tl), the one exponential decay constant in the range 12-38 ns for different compositions, the maximum emission of light in the range 400-450 nm, the high radiation resistance against high energy protons/hadrons, no degradation in optical transmission after gamma-rays irradiation with the dose in the range approximately 5-23 Mrad, the energy resolution for the full energy peak in the range from 6% till 10%.

A fourth task of the given invention is a creation of advanced (Lu_{2-w-x-2y}A_{w}CeₓSi_{1+y})_{1-z}Me_{z}JⱼO scintillation materials having the total silicon concentration from Si_{1.001} till Si_{1.04} and the mole ratios of components (Lu_{2-w-x-2y}+Ceₓ+A_{w})/Si_{1+y}<2; the high density ˜6.8-7.4 g/cm³, the high light output about 60-95% of NaI(Tl), the one exponential decay constant in the range 12-38 ns for different compositions, the maximum emission of light in the range 400-450 nm, the high radiation resistance against high energy protons/hadrons, no degradation in optical transmission after gamma-rays irradiation with the dose in the range approximately 5-23 Mrad, the energy resolution for the full energy peak in the range from 6% till 10%.

Aspect #2.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, and characterised in that the scintillation material is a crystal.

A fifth technical task solved by this invention is a production of large crystalline boules having a high light output of a luminescence and high radiation hardness over all volume, grown by directional crystallization method, in particular, the Kyropoulas and Czochralski methods.

The particular specific forms of invention implementation the technical result, expressed in a decreasing of production cost of scintillation elements and a reproducibility of physical properties of the samples from boule to boule at mass production, is achieved by method of making of scintillating material. A single crystal is being grown by a method from a melt made from the charge of the composition defined by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1++y})_{1-z}Me_{z}JⱼO_{q}. A growth of crystals from a melt composition allows to use about 50-70% of melt, this appreciably cheapens a cost of scintillation elements.

A sixth technical task in the specific forms is a composition of scintillation crystals having intensity and an afterglow time less than the known lutetium and lutetium-yttrium oxyorthosilicate crystals have, and a light output of proposed substance is comparable or higher than a lutetium and a lutetium-yttrium oxyorthosilicate has.

Aspect #3. A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, and characterised in that the scintillation material is a crystal having additionally the inclusions with the chemical formula selected from materials of Lu₂Si₂O₇, SiO₂ and Lu₂O₃ with sub-micron size in the range 1-400 nm and a quantity not exceeding 0.5 wt % of scintillation material.

A seventh technical task solved by this invention is a production of large crystalline boules, having a high light output of a luminescence and high radiation hardness over all volume, grown by the Kyropoulas and Czochralski methods, having additionally the sub-micron inclusions.

An eighth technical task in the specific forms is a small percent of losses of valuable scintillation crystal materials during production of large monolithic scintillation block about 60×60×12 mm³, in comparison with multi-pixels detector, having hundred or thousand pixels with size about 1×1×12 mm³ or 2×2×25 mm³, because significant percent of losses expensive crystal material during sawing and polishing of scintillation elements for Positron Emission Tomography (PET), Single Photon Emission Computed Tomography (SPECT), micro-tomographs—MicroPET.

In the given invention a new is that the scintillation material is a crystal having additionally the inclusions with sub-micron size in the range 1-400 nm. For example, it is applied in design of the small animal PET scanner on base of 6 monolithic scintillation detectors. Each monolithic crystal block has size about 60×60×12 mm³. A solid-state semiconductor photodetectors optically coupled to one or both polished 60×60 mm surface of monolithic a LFS crystal, having additionally the sub-micron inclusions. The solid-state semiconductor photodetector includes an array of discrete sensitive areas disposed across of 60×60 mm² surface of LFS monolithic crystal block and each sensitive area contains an array of discrete micro-pixelated avalanche photodiodes.

The present monolithic crystal blocks having additionally the inclusions with sub-micron size is directed to scintillation detectors capable of detecting the position or depth of gamma photon interactions occurring within a scintillator, thereby improving the resolution of ring based positron emission tomography imaging systems in: (1) the whole-body imaging during diagnostic at early stage cancer of a patient in hospitals; (2) the neuro-imaging of human brain PET; and (3) the small animal PET scanner.

Aspect #4. A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} and characterised in that the scintillation material is a ceramic.

The solutions of said tasks are achieved due to the use of scintillation substances both crystal and ceramics for X-ray computer fluorography; for high-dose x-ray applications with energies up to 160 keV in systems for low-density materials imaging in airport security systems, in systems for X-ray control of quality using a non-destructive testing of solid state structure; for the Gamma-ray systems, which it used a Cesium-137 or Cobalt-60 gamma source, for the inspection of trucks and cargo containers for concealed contraband, smuggled goods, and for manifest verification.

Aspect #5.

A scintillation crystal materials represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, and, wherein the cerium (Ce) content is in the range 100-3100 ppmW and the calcium (Ca) content is in the range 1-600 ppmW.

A technical result, namely a production of large crystalline boules, having a short decay time and a high light output of a luminescence over all volume, a reproducibility of scintillation properties of monocrystals grown at mass production, a small percent of losses of valuable scintillation crystal material elements during sawing and manufacturing of scintillation elements, is achieved due to the growing of scintillation crystals having: (1) cerium ions concentration in the range from 100 ppmw or x=3×10⁻⁴ f.u. till 3100 ppmw or x=1×10⁻² f.u, and (2) calcium ions concentration in the range from 1 ppmw or z=5.7×10⁻⁶ f.u. till 600 ppmw or z=6.8×10⁻³ f.u.

Aspect #6.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, and, wherein:

Me is in a quantity not exceeding 10 ppmW for the Li, B, Al, Ti, V, Cr, Mn, Co, Ni, Ge, Zr, Sn, Hf ions;

less than 30 ppmW for the Na, K, Cu, Ag, Zn, Sr, Cd, Fe, Pr, Nd, Sm, Eu, Th, Dy, Ho, Er, Tm, Yb ions;

less than 100 ppmW for the Mg, Ga, La ions;

in the range 1-600 ppmW for the Ca;

less than 50 ppmW for N, F, Cl, S ions;

less than 100 ppmW for P ions.

A technical result—the creation of scintillation materials having a comparatively low cost, a high light yield and a homogeneity of scintillation properties, is achieved due to the use of low cost Lu₂O₃. Decreasing the cost of one crystal growth process up to 2 times for (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} scintillated materials using a low cost Lu₂O₃, having the upper of level impurities ions; (1) in a quantity not exceeding 10 ppmW for the Li, B, Al, Ti, V, Cr, Mn, Co, Ni, Ge, Zr, Sn, Hf ions; (2) less than 30 ppmW for the Na, K, Cu, Ag, Zn, Sr, Cd, Fe, Pr, Nd, Sm, Eu, Tb, Dy, Ho, Er, Tm, Yb ions; (3) less than 100 ppmW for the Mg, Ga, La ions; (4) in the range 1-600 ppmW for the Ca; (5) less than 50 ppmW for N, F, Cl, S ions; (6) less than 100 ppmW for P ions in scintillated materials.

Aspect #7.

A scintillation material represented by the chemical formulas (Lu_{2-w-x+2y}A_{w}CeₓSi_{1-y})_{1-z}Me_{z}JⱼO_{q} and (Lu_{2-x-2y}A_{w}CeₓSi_{1+y})_{1-z}Me_{z}JⱼO_{q}, wherein the cerium (Ce) content is in the range 100-3100 ppmW, the calcium (Ca) content is in the range 1-600 ppmW, and the scandium (Sc) content is in the range 0-20000 ppmW.

A technical result, namely a production of large crystalline boules, having a short decay time and a high light output of a luminescence over all volume, a reproducibility of scintillation properties of monocrystals grown at mass production, a small percent of losses of valuable scintillation crystal material elements during sawing and manufacturing of scintillation elements, is achieved due to the growing of scintillation crystals having: (1) cerium ions concentration in the range from 100 ppmw or x=3×10⁻⁴ f.u. till 3100 ppmw or x=1×10⁻² f.u, and (2) calcium ions concentration in the range from 1 ppmw or z=5.7×10⁻⁶ f.u. till 600 ppmw or z=6.8×10⁻³ f.u., (3) scandium ions concentration in the range from 0 ppmw or z=0 f.u. till 20000 ppmw (2 wt. %) or z=0.19 f.u. The upper boundary of scandium ions content in a crystal relative to a lutetium is determined experimentally. In a case of further increasing of expensive Sc₂O₃ content in an initial melt and, consequently, in a crystal, and, as a result, the reduces a manufactory cost may not be reached.

Aspect #8.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, and, wherein the cerium (Ce) content is in the range 100-3100 ppmW, the calcium (Ca) content is in the range 1-600 ppmW, the scandium (Sc) content is in the range 0-20000 ppmW and the yttrium (Y) content is in the range 0-60000 ppmW (6 wt. %).

Another technical result—mass production of large crystalline boules, having a short decay time and a high light output of a luminescence over all volume, a reproducibility of scintillation properties of monocrystals grown at mass production, a small percent of losses of valuable scintillation crystal material elements during sawing and manufacturing of scintillation elements, is achieved due to the growing of scintillation crystals having: (1) cerium ions concentration in the range from 100 ppmw or x=3×10⁻⁴ f.u. till 3100 ppmw or x=1×10⁻² f.u, and (2) calcium ions concentration in the range from 1 ppmw or z=5.7×10⁻⁶ f.u. till 600 ppmw or z=6.8×10⁻³ f.u., (3) scandium ions concentration in the range from 0 ppmw or z=0 f.u. till 20000 ppmw (2 wt. %) or z=0.19 f.u., (4) yttrium ions concentration in the range from 0 ppmw or z=0 f.u. till 60000 ppmw (6 wt. %) or z=0.29 f.u.

The upper boundary of yttrium ions content in a crystal relative to a lutetium is determined experimentally. In a case of further increasing of a Y₂O₃ content in an initial melt and, consequently, in a crystal, and, as a result, the high crystal density may not be reached.

Aspect #9.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, wherein the cerium (Ce) content is in the range 100-6400 ppmW, the calcium (Ca) content is in the range 1-600 ppmW, scandium (Sc) content is in the range 0-20000 ppmW and the gadolinium (Gd) content is in the range 0-356000 ppmW (35.6 wt. %).

Another technical result—mass production of large crystalline boules, having a short decay time and a high light output of a luminescence over all volume, a reproducibility of scintillation properties of monocrystals grown by a method from a melt, a small percent of losses of valuable scintillation crystal material elements during sawing and manufacturing of scintillation elements, is achieved due to the growing of scintillation crystals having: (1) cerium ions concentration in the range from 100 ppmw or x=3×10⁻⁴ f.u. till 6400 ppmw or x=2×10⁻² f.u, (2) calcium ions concentration in the range from 1 ppmw or z=5.7×10⁻⁶ f.u. till 600 ppmw or z=6.8×10⁻³ f.u., (3) scandium ions concentration in the range from 0 ppmw or z=0 f.u. till 20000 ppmw (2 wt. %) or z=0.19 f.u., (4) gadolinium ions concentration in the range from 0 ppmw or z=0 f.u. till 356000 ppmw (35.6 wt. %) or z=1 f.u.

The upper boundary of gadolinium ions content in a crystal relative to a lutetium is determined experimentally. In a case of further increasing of a Gd₂O₃ content in an initial melt and, consequently, in a crystal, and, as a result, the decreasing of light output is achieved in comparison with small gadolinium concentration in melt.

The lower limit for the cerium ions is determined by the fact that at the content of Ce³⁺ in the quantity of less than 3×10⁻⁴ f. units, the effectiveness of a scintillation luminescence of Ce³⁺ becomes insignificant because of the small concentration. With the concentration of cerium lower than the above limit, the implementation of the technical task may not be reached, namely it is not practical to achieve a light yield sufficient for practical utilization.

For practical applications the crystals, having high gadolinium concentration, the higher cerium ions concentration are required, because such crystals have the shorter decay time. However, the very high cerium concentration leads to the several negative results. Firstly, the crystals with a high cerium concentration have a bad optical quality; the scattering centres are presented in bottom of crystals. Secondly, a reducing of light yield is taken place, because of both a lowering of optical quality and a decreasing of quantum efficiency, which happens due to an interaction of neighbour cerium ions, so named, an effect of concentration quenching of luminescence. Therefore, the upper limit for cerium ions is set 0.02 f. units for high gadolinium concentration of given invention. These limits are defined by experimentally. When the concentration is above indicated limits, then the formation of numerous scattering centres (size a few microns) of light takes place during crystallization and, therefore, the implementation of such defective crystals in medical and technical devices is not practical.

Aspect #10.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the decay time is in the range 12-45 ns for application in TOF PET, DOI PET, MicroPET scanners.

The technical result—the creation of scintillation substance having short decay time, a high light yield, a large density, a homogeneity and reproducibility of scintillation properties during mass production is achieved due to the use of materials based on a silicate represented by the chemical formulas (Lu_{2-w}_{x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}.

The concept of time-of-flight means simply that for each annihilation event, it note precise time that each of the coincident photons is detected and calculate the difference. Since the closer photon will arrive at its detector first, the difference in arrival times helps pin down the location of the annihilation event along the line between the two detectors. The TOF PET scanner has significant advantages, since conventional PET image quality degrades noticeably for large patients due to increased attenuation, which leads to the lost of true counts and increase of scatter counts. In fact, the difference in the noise-equivalent count-rate for a heavy patient (e.g. 120 kg) compared to the slim patient (e.g. 50 kg) is about a factor of six. Thus, to achieve comparable image quality for heavy patient, usual PET scanner would need to scan for six times longer, which is clinically difficult. The promise of TOF PET is that it has the potential to improve the imaging quality in heavy patients, precisely where it is needed most.

The technical result, namely the timing resolutions even about 175 ps are shown for scintillation materials having decay time about 30 ns. The timing resolution even about 100 ps can be achieved between two (Lu_{2-w-x+2y}A_{w}CeₓSi_{1-y})_{1-z}Me_{z}JⱼO_{q} or two (Lu_{2-w-x-2y}A_{w}CeₓSi_{1+y})_{1-z}Me_{z}JⱼO_{q} scintillators, having decay time about 12-15 ns and high light output, and modern super fast PMT and fast electronic for registration.

Aspect #11.

A scintillation material represented by the chemical formulas (Lu_{2-w-x+2y}A_{w}CeₓSi_{1-y})_{1-z}Me_{z}JⱼO_{q} and (Lu_{2-w-2y}A_{w}CeₓSi_{1+y})_{1-z}Me_{z}JⱼO_{q}, in which the decay time is in the range 12-35 ns for detection of elementary particles and nuclei in high-energy physics.

The technical result in the specific forms of implementation, expressed in a decreasing of production cost of scintillation elements and a reproducibility of physical properties of the samples from boule to boule at mass production, is achieved due to the use the (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} in the form of a single crystal, having the following priority of scintillation properties: (i) high density, (ii) not a radiation damage after irradiations by large doze of gamma-rays and protons, (iii) short decay time in the range 12-35 ns, (iv) good energy resolution, (v) homogeneity of scintillation properties at mass production of thousand bars with size up to 25×25×280 mm or at mass production of thousand active plates with size up to 25×25×5 mm³ of a “Shashlik”-type readout for the Large Hardron Collider.

Aspect #12.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the light output is in the range 35000-41000 ph/Mew for application in medical imaging systems.

A technical result in the specific forms of implementation is achieved by way of using a scintillation (Lu_{2-w-x+2y}A_{w}CeₓSi_{1-y)}_{1-z}Me_{z}JⱼO_{q} and (Lu_{2-w-x-2y}A_{w}CeₓSi_{1+y})_{1-z}Me_{z}JⱼO_{q} materials in the form of a single crystal, having a light output in the range 35000-41000 ph/Mew.

From Ce_{0.0014}Lu_{1.977}Y_{0.037}Ca_{0.001}Si_{0.992}O_{5.007} crystal it was produced polished 3×3×10 mm³ pixels. The orientation attached by 3×3 mm² face to the PMT is used in the PET scanners for the neuro-imaging of human brain. For these orientation the 5 pixels shown the light output about 41000 ph/MeV.

Aspect #13.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the light output is in the range 20000-38000 ph/Mew for detection of elementary particles and nuclei in high-energy physics.

The particular specific forms of invention implementation the technical result, expressed in a decreasing of production cost of large scintillation elements, having the light output in the range 20000-38000 ph/Mew, reducing a crystal cracking during a cutting, and a reproducibility of physical properties of the samples from boule to boule at mass production, is achieved by way of a growing of single crystal by Czochralski method and a growing of crystal by Kyropoulos method. A new in the given technology of production it is the single crystal being grown by Czochralski method and also by Kiropoulas method from a melt made from the charge of the composition defined by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y)}_{1-z}Me_{z}JⱼO_{q} using a low cost (high impurity) Lu₂O₃.

Aspect #14.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the density is in the range 6.8-7.42 g/cm³.

In the specific forms of implementation the detailed technical result, expressed in a decreasing of production cost by an insignificant decrease of density is achieved by the growing of a scintillation substance, characterised in that the composition of the substance in the form of a single crystal is represented by the chemical formula (Lu_{2-w-x+2y}A_{w}CeₓSi_{1-y})_{1-z}Me_{z}JⱼO_{q} and (Lu_{2-w-x-2y}A_{w}CeₓSi_{1+y)}_{1-z}Me_{z}JⱼO_{q}. The substitution of heavy expensive lutetium for at least one comparatively light element selected from the Gd, Y group reduces a manufactory cost, but may cause an inconsiderable decreasing of density. The cheaper scintillation crystals having a smaller density of 6.8-7.42 g/cm³ and a high light yield are useful for numerous applications, for example, in X-ray computer fluorography; non-destructive testing of solid state structure; and security systems.

Aspect #15.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which a crystal has high radiation hardness and no degradation in optical transmission in the range 400-450 nm after irradiation by gamma ray with the dose of approximately in the range 5-23 Mrad.

A technical result—mass production of large crystalline boules, having over large boule volume a high light output of a luminescence and high radiation hardness and no degradation in optical transmission in the range 400-450 nm after irradiation by gamma ray with the dose in the range 5-23 Mrad, a reproducibility of scintillation properties of monocrystals grown during mass production, is achieved by way of growing of scintillating single crystal by a method from a melt made from the charge (Lu_{2-w-x+2y}A_{w}CeₓSi_{1-y)}_{1-z}Me_{z}JⱼO_{q} and (Lu_{2-w-x-2y}A_{w}CeₓSi_{1+y})_{1-z}Me_{z}JⱼO_{q}, for example, a calcium co-doped compositions in TABLE 1.

Aspect #16.

A scintillation material materials represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which a crystal has high radiation hardness and no degradation reduction in optical transmission in the range 400-450 nm after irradiation by high-energy protons of 155 MeV/c protons with fluency 4×10¹² cm⁻².

Another technical result—mass production of large crystalline boules, having a high light output of a luminescence and no degradation reduction in optical transmission in the range 400-450 nm after irradiation by high-energy protons of 155 MeV/c protons with fluency 4×10¹² cm⁻², a reproducibility of scintillation properties of monocrystals grown during mass production, is achieved by way of growing of scintillating single crystal represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in particularly calcium co-doped Ce_{0.0014}Lu_{1.977}Y_{0.037}Ca_{0.001}Si_{0.992}O_{5.007} (LFS-3) crystal.

During Czochralski growth process a LFS crystal boule has continuous shift of the chemical compositions from top to bottom, because the segregation coefficients of the host crystal components and doping ions are differed from unit. Distribution or segregation coefficient of an element is a ratio of concentration of element in a crystal, C_{crystal}, to concentration of the element in a melt, Cₘₑₗₜ, namely, k=C_{crystal}/Cₘₑₗₜ. A distribution coefficient of yttrium is 0.75; a distribution coefficient of calcium is 0.4; a distribution coefficient of scandium is 1.22, a distribution coefficient of cerium is 0.365 (Example 4).

There are two crystallographic non-equivalent positions with coordination number 6 and 7 for Lu in oxyorthosilicate lattice host, the distribution coefficients of cerium substitutes for Lu placed in 7-fold coordination, Ce(7)O₇, is 0.39, the distribution coefficient of cerium substitutes for Lu in 6-fold coordination, Ce(6)O₆, is 0.17. The relative population of Ce in each position in LFS crystal is found to be about 62% for Ce7 and 38% for Ce6. A total distribution coefficient of cerium in both positions is 0.365.

In growth process from starting melt composition CeₓLu_{2-x-z+2y}Y_{w}Ca_{z}Si_{1-y}O_{5+q} began growing of crystal having: (a) Ce concentration is about 30%-36% than concentration in melt; (b) yttrium concentration is 75%-85% than concentration in melt for different yttrium concentrations in starting melt compositions; (c) calcium concentration is about 40% than concentration in melt; (d) silicon concentration is depended from oxygen concentration in growth atmosphere, the vaporization speed from surface of melt, the ratio (Lu+Ce+Y+Ca)/Si in the melt, therefore this parameters determinate that the silicon concentration in growing crystal may change in the range 99%-101% in comparison with concentration in the melt; (e) In growing crystal the lutetium concentration is in the range 100%-102% of concentration in a melt. It is new in this invention, that there are no degradation reduction in optical transmission in the range 400-450 nm after irradiation by high-energy protons of 155 MeV/c protons with fluency 4×10¹² for top, middle part and bottom of large LFS boules after co-doping by calcium ions.

Radiation hardness of LFS crystals is important in many applications of radiation detectors. Currently there is a strong demand for ultra radiation resistant crystals for electromagnetic calorimeters located near beam-pipe, in the end-cap region, and capable of working under heavy condition during an extended length of time.

Aspect #17.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the decay time is in the range about 12-35 ns for high-dose X-ray applications with energies up to 160 keV in systems for low-density materials imaging in airport security systems, in systems for X-ray control of quality using a non-destructive testing of solid state structure.

The (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} materials in form of a powder or a crystal (having additionally the inclusions with the chemical formula selected from materials of Lu₂Si₂O₇, SiO₂ and Lu₂O₃ with sub-micron size in the range 1-400 nm) or a ceramic are a high effective and fast scintillation materials for application in airports during baggage screening systems having two or more X-ray sources in the range from 5 kV till 160 kV.

Aspect #18.

A scintillation material represented by the chemical formulas (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, in which the decay time is in the range 12-35 ns for the Gamma-ray systems, which it is used a Cesium-137 or Cobalt-60 gamma source, for the inspection of trucks and cargo containers for concealed contraband, smuggled goods, and for manifest verification.

A technical result—a high light output of a luminescence and high radiation hardness and no degradation in optical transmission in the range 400-450 nm after irradiation by gamma ray with the dose up to 23 Mrad, it is important for application in Gamma-ray systems, which it is used a Cesium-137 or Cobalt-60 gamma source. Radiation hard scintillation material is achieved by way of growing of scintillating single crystal by a method from a melt made from the charge (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, for example, a calcium co-doped compositions disclosed in TABLE 1.

Aspect #19.

A cerium-activated lutetium based oxyorthosilicate scintillation crystal having an emission maximum in the range of 400-450 nm, and having a scandium (Sc) concentration of greater than 50 ppmw. Said scandium co-doped scintillation crystals have a technical result—mass production of large crystalline boules, having a high light output of a luminescence and the decay time is in the range 12-35 ns for application in TOF PET, DOI PET, MicroPET scanners; for detection of elementary particles and nuclei in high-energy physics; for X-ray control of quality using a non-destructive testing of solid state structure; for the inspection of trucks and cargo containers for concealed contraband, smuggled goods, and for manifest verification.

Aspect #20.

A cerium-activated lutetium based oxyorthosilicate scintillation crystal having emission maximum in the range 400-450 nm, having the decay time in the range 12-32 ns and characterised in that the investigated by a commercial system for chemical elemental analysis, the said crystal is comprised of chemical elements: Matrixes (Major) elements: silicon (Si), oxygen (O), lutetium (Lu); Doping elements: the cerium (Ce) content is in the range 100-3100 ppmW and the calcium (Ca) content is in the range 5-600 ppmW.

Impurity chemical elements: in a quantity not exceeding 10 ppmW for the Li, B, Al, Ti, V, Cr, Mn, Co, Ni, Ge, Zr, Sn, Hf ions; less than 30 ppmW for the Na, K, Cu, Ag, Zn, Sr, Cd, Fe, Pr, Nd, Sm, Eu, Tb, Dy, Ho, Er, Tm, Yb ions; less than 100 ppmW for the Mg, Ga, La ions; less than 50 ppmW for F, Cl, S ions; less than 100 ppmW for P ions.

The said scintillation crystals have a technical result of this invention: the use as a raw materials the Lu₂O₃ having the purity of 99.9% instead of Lu₂O₃ with a purity of 99.99% in the known patents. The low price Lu₂O₃ allows decreasing the cost of a melting raw materials about 2 times for grown cerium-activated lutetium based oxyorthosilicate scintillation crystals. The impurities Sc, Y, La, Ce, Mg, Ca, Gd, Si, S, F, Cl ions have not a significant negative influence; therefore it is possible a high concentration of this ions in low cost Lu₂O₃. For measurements of concentration of doping ions and impurites ions it is possible to apply different commercial systems for chemical elemental analysis, for example, Glow Discharge Mass Spectroscopy (GDMS) analysis or Inductively Coupled Plasma Mass Spectrometry (ICP-MS). A simultaneous ICP-MS can record the entire analytical spectrum from lithium to uranium. Also within many decades the GDMS analysis is widely applied in a science and engineering to fast measurement of concentration impurites ions from lithium to uranium.

Aspect #21.

A scintillation lutetium based oxyorthosilicate crystal having emission maximum in range 400-450 nm, having the decay time in the range 12-32 ns, having the density in the range 6.8-7.42 g/cm³ and comprising a lutetium (Lu) and cerium (Ce) and characterised in that the investigated by a commercial system for chemical elemental analysis, the said crystal is comprised of chemical elements: Matrixes (Major) elements: silicon (Si), oxygen (O), lutetium (Lu), and at least one element selected from the group consisting of scandium (Sc), yttrium (Y), gadolinium (Gd.); Doping elements: the cerium (Ce) content is in the range 100-3100 ppmW and the calcium (Ca) content is in the range 5-600 ppmW.

The said scintillation crystals have a technical result of this invention: the use as a raw materials the Lu₂O₃ having the purity of 99.9% instead of Lu₂O₃ with a purity of 99.99% in the known patents. The low price Lu₂O₃ allows decreasing the cost of a melting raw materials about 2 times for grown cerium-activated lutetium based oxyorthosilicate scintillation crystals. The impurities Sc, Y, La, Ce, Mg, Ca, Gd, Si, S, F, Cl ions have not a significant negative influence; therefore it is possible a high concentration of this ions in low cost Lu₂O₃.

Aspect #22.

A large single crystal boule of cerium-activated lutetium-based oxyorthosilicate made from an off-stoichiometric melt of starting oxides, wherein the starting oxides have a purity of about 99.9% and include at least cerium oxide, lutetium oxide, and silicon oxide, and wherein at least 50% of the melt becomes part of the large crystal boule.

The technical result—A large single crystal boule of cerium-activated lutetium-based oxyorthosilicate made from an off-stoichiometric melt of starting oxides (Example 6, 7, 11, 13, 14). The technical result—the creation of scintillation materials having a comparatively low cost of starting oxides, wherein the starting oxides have a purity of about 99.9% (Example 9). The technical result—wherein at least 50% of the melt becomes part of the large crystal boule (Example 6, 7).

Aspect #23.

A scintillation lutetium-based oxyorthosilicate crystal having emission maximum in range 400-450 nm, having the decay time in the range 12-32 ns and having hard radiation hardness, the said radiation hardness it is mean no-degradation in optical transmission in the range 400-450 nm after irradiation by gamma ray with the dose in the range 5-23 Mrad, for detection of elementary particles and nuclei in high-energy physics.

Said scintillation oxyorthosilicate crystal crystals have a technical result—mass production of large crystalline boules, having a high light output and the decay time is in the range 12-35 ns and having hard radiation hardness, the said radiation hardness it is mean no-degradation in optical transmission in the range 400-450 nm after irradiation by gamma ray with the dose in the range 5-23 Mrad (TABLE 1, Example 14).

Aspect #24.

A scintillation lutetium-based oxyorthosilicate crystal having emission maximum in range 400-450 nm, having the decay time in the range 12-32 ns for application in TOF PET and DOI PET scanners, MicroPET scanners; for detection of elementary particles and nuclei in high-energy physics; for X-ray control of quality using a non-destructive testing of solid state structure; for the inspection of trucks and cargo containers for concealed contraband, smuggled goods, and for manifest verification.

Said scintillation oxyorthosilicate crystals have a technical result—mass production of large crystalline boules, having a high light output and the decay time is in the range 12-32 ns (TABLE 1, Example 4, 10, 14, 16).

Aspect #25.

A method of production of a scintillation cerium doped lutetium-based oxyorthosilicate including LFS, LSO, LYSO, LGSO crystals having the decay time in the range 12-30 ns, and said method is annealing of a crystal samples in vacuum or 100% Argon atmosphere at temperature about 1400-1600° C. during time about 6-24 hours (See of Example 17).

In the given invention a new is that during annealing of a crystal samples at high temperature 1400-1600° C., the process of diffusion of oxygen ions from the body of said samples into vacuum or flow gas of 100% Argon was observed. After annealing in vacuum at 1400° C. each polished pixel/sample has lower weight than the weigh before annealing and the 6 polished surfaces have not a degradation quality of polished surfaces.

The decomposition of scintillation cerium doped lutetium-based oxyorthosilicates (LFS, LSO, LYSO) exists in high vacuum at 1750° C., there are vaporization of oxygen and mono oxide SiO. The surfaces of sample decomposed into Lu₂O₃ and the volume have dark blue colour in results of significant loss of oxygen.

Aspect #26.

A method of production of a scintillation cerium doped lutetium-based oxyorthosilicate including LFS, LSO, LYSO, LGSO crystals having hard radiation hardness, the said radiation hardness it is mean no-degradation in optical transmission in the range 400-450 nm after irradiation by gamma ray with the dose in the range 5-23 Mrad, and said method is annealing of a crystal samples in vacuum or 100% Argon atmosphere at temperature about 1400° C. (See Example 18).

Aspect #27.

A method of production of a scintillation cerium doped lutetium-based oxyorthosilicate including LFS, LSO, LYSO, LGSO crystals, and said method is annealing of a crystal samples in vacuum or 100% Argon atmosphere during time about 6-24 hours. (See Example 17).

Aspect #28.

A method of production of a scintillation lutetium-based oxyorthosilicate including LFS, LSO, LYSO, LGSO crystals, and said method is annealing of a crystal samples having size of said crystal samples approximately cross-section from 3×3 mm till 25×25 mm and the thickness from 2 mm till 25 mm. (See Examples 4, 10, 15, 16).

Aspects #29.

A scintillation cerium doped lutetium-based oxyorthosilicate including LFS, LSO, LYSO, LGSO crystal samples having hard radiation hardness, and the said radiation hardness it is mean no-degradation in optical transmission in the range 400-450 nm after irradiation by gamma ray with the dose in the range 5-23 Mrad, and said crystal samples have calcium (Ca) concentration approximately from 5 ppmW till 400 ppmW, and magnesium (Mg) concentration approximately from 0 ppmW till 200 ppmW, and cerium concentration approximately from 150 ppmW till 600 ppmW. (See TABLE 1, Examples 4, 6, 11, 14, 15, 18).

Aspect #30.

A method of production of a scintillation cerium doped lutetium-based oxyorthosilicate including LFS, LSO, LYSO, LGSO crystals having the energy resolution for the full energy peak in the range from 6% till 10%, and said method is annealing of a crystal samples in vacuum or gas atmosphere 80-100% volume of argon+0-20% volume of CO₂ at temperature about 1400-1600° C. during time about 6-24 hours. The specified method includes the following stages: (1) The growth of LFS, LSO, LYSO, LGSO single crystals by Czochralcki (CZ) or Kyropoulas methods; (2) The cutting of grown boule at samples having approximately cross-section from 3×3 mm till 25×25 mm and the thickness from 2 mm till 25 mm; (3) Annealing of a crystal samples in vacuum or gas atmosphere 80-100% volume of argon+0-20% volume of CO₂ at temperature about 1400-1600° C. during time about 6-24 hours; (4) At the final stage from this annealed samples it was produced, for example, the polished pixels for application in TOF PET and DOI PET scanners or active scintillated plates with size up to 25×25×5 mm³ of a “Shashlik”-type readout for the High-Luminosity Large Hardron Collider (HL-LHC). (See Examples 16, 17, 18).

TABLE 1 shows the results of testing of the synthesised scintillating substances. The Concentration of doping ions (ppmw), Decay time (ns), Light yield (relative units), Degradation transmission at 420 nm due to γ-rays irradiation are compared for different compounds. The values of light yield are presented in units relative to a light yield of “the reference” Ce_{0.0013}Lu_{2.02}Sc_{0.003}Si_{0.99}O_{5.012} sample.

TABLE 1
Comparison of scintillating characteristics and radiation hardness of
scintillation crystals of different compositions:

| | Characteristics of the scintillation crystals | | | | |
|---|---|---|---|---|---|
| | Concentration | | | | Degradation |
| | of | | | | transmission |
| | doping ions | | Light | | at 420 nm |
| Composition of scintillation material or | (ppmw) in | Decay | yield, | Density | due to γ- |
| melt composition. Concentration of | melt or | time | (relative | (gram/ | rays |
| impurities from raw materials (ppmw). | crystal | (ns) | units) | cm³) | irradiation |
| 1. Crystal composition: | Ce = 100 | 42 | 0.6 | 7.406 | 15%/cm at |
| Ce_{0.00033}Lu_{2.006}Sc_{0.0032}Si_{0.997}O_{5.008} | Sc = 340 | | | | 5 * 10⁶ rad |
| and equivalent formula: | | | | | |
| Ce_{0.00033}Lu_{1.9965}Sc_{0.0032}Si_{0.9922}O_{4.9844} | | | | | |
| Impurities ions: | | | | | |
| <11 ppmw - Cl, | | | | | |
| <2 ppmW for a Li, Na, K, Al, Ca, Cu, | | | | | |
| Mg, Zn, Sr, B, Ga, Ti, Zr, Sn, Hf, La, | | | | | |
| Pr, Nd, Sm, Eu, Tb, Dy, Ho, Er, Tm, Yb | | | | | |
| ions; | | | | | |
| 2. Crystal composition: | Ce = 165 | 40 | 0.81 | 7.410 | 7%/cm at |
| Ce_{0.00053}Lu_{2.009}Sc_{0.0033}Si_{0.995}O_{5.009} | Sc = 315 | | | | 5 * 10⁶ rad |
| and equivalent formula: | | | | | |
| Ce_{0.00033}Lu_{1.9962}Sc_{0.0033}Si_{0.9887}O_{4.9774} | | | | | |
| Impurities ions: | | | | | |
| 11 ppmw - Cl, 5 ppmw - P. | | | | | |
| 3 ppmW - Ca, 1.5 ppmW - Yb,. | | | | | |
| <2 ppmW for a Li, Na, K, Al, | | | | | |
| <0.5 ppmW for a Li, Na, K, Cu, Mg, Zn, | | | | | |
| Sr, B, Ga, Ti, Zr, Sn, Hf, La, Pr, Nd, | | | | | |
| Sm, Eu, Tb, Dy, Ho, Er, Tm ions; | | | | | |
| 3. Crystal composition: | Ce = 390 | 39 | 1.0 | 7.414 | 4%/cm at |
| Ce_{0.0013}Lu_{2.02}Sc_{0.0003}Si_{0.99}O_{5.012} | Sc = 290 | | | | 5 * 10⁶ rad |
| and equivalent formula: | | | | | |
| Ce_{0.0013}Lu_{1.9967}Sc_{0.002}Si_{0.9786}O_{4.9572} | | | | | |
| 4. Crystal composition: | Ce = 960 | 28 | 1.12 | 7.383 | Not up to |
| Ce_{0.0031}Lu_{1.997}Y_{0.0023}Sc_{0.031}Ca_{0.0024}Si_{0.983}O_{5.016} | Ca = 210 | | | | 23 * 10⁶ rad |
| and equivalent formula: | Y = 440 | | | | |
| Ce_{0.0031}Lu_{1.9619}Y_{0.0026}Sc_{0.0305}Ca_{0.0024}Si_{0.9657}O_{4.93} | Sc = 3050 | | | | |
| Impurities ions: | | | | | |
| <5 ppmW for a Li, B, Al, Ti, Zr, Sn, | | | | | |
| Hf, Ga ions; | | | | | |
| <10 ppmW for a Na, K, Zn, Sr, La, Pr, | | | | | |
| Nd, Sm, Eu, Tb, Dy, Ho, Er, Tm ions; | | | | | |
| <30 ppmW for a Mg, Yb ions. | | | | | |
| 5. Crystal composition: | Ce = 560 | 34 | 1.05 | 7.230 | 5.2%/cm at |
| Ce_{0.00185}Lu_{1.917}Y_{0.110}Si_{0.986}O_{5.015} | Y = 2120 | | | | 23 * 10⁶ rad |
| and equivalent formula: | | | | | |
| Ce_{0.001852}Lu_{1.8897}Y_{0.108}Si_{0.972}O_{4.943} | | | | | |
| Impurities ions: | | | | | |
| 14 ppmw - Yb, 12 ppmw - Ca, | | | | | |
| 10 ppmw - B, | | | | | |
| <5 ppmW - Al. Na, K, Cl, S, | | | | | |
| <1 ppmW for a Pr, Nd, Sm, Eu, Tb, Dy, | | | | | |
| Ho, Er, Tm, La ions; | | | | | |
| 6. Crystal composition: | Ce = 410 | 35 | 1.23 | 7.358 | Not up to |
| Ce_{0.0014}Lu_{1.977}Y_{0.037}Ca_{0.001}Si_{0.992}O_{5.007} | Ca = 85 | | | | 23 * 10⁶ rad |
| and equivalent formula: | Y = 8500 | | | | |
| Ce_{0.0014}Lu_{1.961}Y_{0.037}Ca_{0.001}Si_{0.984}O_{4.967} | | | | | |
| Impurities ions: | | | | | |
| 10 ppmw - Yb,. 8 ppmw - Na, Cl. | | | | | |
| <5 ppmW for a Li, Na, Al, K, Cu, Mg, | | | | | |
| Zn, Sr, B, Ga, Ti, Zr, Sn, Hf, La, Pr, Nd, | | | | | |
| Sm, Eu, Tb, Dy, Ho, Er, Tm ions; | | | | | |
| 7. Crystal composition: | Ce = 210 | 34 | 1.17 | 7.407 | 4.8%/cm at |
| Ce_{0.0007}Lu_{1.996}Sc_{0.0062}Li_{0.00037}Si_{0.998}O_{5.001} | Sc = 600 | | | | 5 * 10⁶ rad |
| and equivalent formula: | Li = 6 | | | | |
| Ce_{0.0007}Lu_{1.9927}Sc_{0.0062}Li_{0.00037}Si_{0.996}O_{4.99} | | | | | |
| Impurities ions: | | | | | |
| 11 ppmw - Yb, 9.5 ppmw - Cl, | | | | | |
| 3 ppmw - Ca, | | | | | |
| <2 ppmw Al, Mg, P, S, | | | | | |
| <1 ppmW for a Na, K, Cu, Zn, Sr, B, | | | | | |
| Ga, Ti, Zr, Sn, Hf, La, Pr, Nd, Sm, Eu, | | | | | |
| Tb, Dy, Ho, Er, Tm ions; | | | | | |
| 8. Melt composition: | Ce = 540 | 33 | 1.20 | 7.400 | 0.8%/cm at |
| Ce_{0.002}Li_{0.005}Lu_{2.04}Sc_{0.005}Si_{0.975}O_{5.032} | Sc = 620 | | | | 23 * 10⁶ rad |
| Impurities ions: | Li = 75 | | | | |
| 12 ppmw - Yb,. 10 ppmw - Ca, | | | | | |
| <0.5 ppmW for a Na, K, Cu, Mg, Zn, Sr, | | | | | |
| B, Ga, Ti, Zr, Sn, Hf, La, Pr, Nd, Sm, | | | | | |
| Eu, Tb, Dy, Ho, Er, Tm ions; | | | | | |
| 9. Melt composition: | Ce = 3700 | 41 | 1.0 | 7.279 | Not up to |
| Ce_{0.012}Lu_{1.887}Y_{0.12}Si_{0.995}O_{5.004} | Y = 23800 | | | | 45 * 10⁶ rad |
| Impurities ions from Lu₂O₃: | | | | | |
| 250 ppmw - Gd, 100 ppmw - Tb. | | | | | |
| <35 ppmW for a Dy, Ho, Er, Tm. | | | | | |
| 100 ppmw - Ca, F. | | | | | |
| 120 ppmw - Si, Cl | | | | | |
| 50 ppmw - Fe. | | | | | |
| 10. Crystal composition: | Ce = 210 | 30 | 1.32 | 7.12 | 0.8%/cm at |
| Ce_{0.00066}Lu_{1.793}Y_{0.211}Ca_{0.0004}Si_{0.997}O_{5.0014} | Ca = 35 | | | | 23 * 10⁶ rad |
| and equivalent formula: | Y = 42400 | | | | |
| Ce_{0.00066}Lu_{1.788}Y_{0.211}Ca_{0.0004}Si_{0.995}O_{4.989} | (4.24 wt. %) | | | | |
| Impurities ions: | | | | | |
| 8 ppmw - Yb, Al, Cl; 6 ppmw - S; | | | | | |
| <5 ppmW for a Na, K, Cu, Mg, Zn, Sr, | | | | | |
| B, Ga, Ti, Zr, Sn, Hf, La, Pr, Nd, Sm, | | | | | |
| Eu, Tb, Dy, Ho, Er, Tm ions; | | | | | |
| 11. Melt composition: | Ce = 1230 | 37 | 0.88 | 7.412 | Not up to |
| Ce_{0.004}Lu_{2.02}Mg_{0.0034}Si_{0.99}O_{5.016} | Mg = 180 | | | | 45 * 10⁶ rad |
| Impurities ions: | | | | | |
| 1 ppmW - Ca, Yb,. | | | | | |
| <0.5 ppmW for a Li, Na, K, Cu, Mg, Zn, | | | | | |
| Sr, B, Ga, Ti, Zr, Sn, Hf, La, Pr, Nd, | | | | | |
| Sm, Eu, Tb, Dy, Ho, Er, Tm ions; | | | | | |
| 12. Melt composition: | Ce = 6400 | 41 | 0.76 | 7.107 | 8%/cm at |
| Ce_{0.02}Lu_{1.244}Gd_{0.715}Zn_{0.02}Si_{0.99}O_{4.97} | Zn = 3000 | | | | 5 * 10⁶ rad |
| Impurities ions: | Gd = 25500 | | | | |
| 8 ppmw - Yb, | (25.5 wt. %) | | | | |
| <0.5 ppmW for a Na, K, Cu, Mg, Zn, Sr, | | | | | |
| B, Ga, Ti, Zr, Sn, Hf, La, Pr, Nd, Sm, | | | | | |
| Eu, Tb, Dy, Ho, Er, Tm ions; | | | | | |
| 13. Melt composition: | Ce = 600 | 33 | 1.2 | 7.400 | 0.8%/cm at |
| Ce_{0.002}Li_{0.002}Lu_{1.983}Sc_{0.005}Si_{1.004}O_{4.994} | Sc = 500 | | | | 23 * 10⁶ rad |
| Impurities ions: | Li = 30 | | | | |
| 35 ppmw - Ca; 9 ppmw - Yb; <0.5 | | | | | |
| ppmW for a Na, K, Cu, Mg, Zn, Sr, B, | | | | | |
| Ga, Ti, Zr, Sn, Hf, La, Pr, Nd, Sm, Eu, | | | | | |
| Tb, Dy, Ho, Er, Tm ions; | | | | | |
| 14. Melt composition: | Ce = 770 | 12-18 | 1.2 | 7.405 | Not up to |
| Ce_{0.0025}Lu_{2.00}Sc_{0.004}Ca_{0.001}Si_{0.997}O_{5.005} | Ca = 90 | for 5 | | | 23 * 10⁶ rad |
| and equivalent formula: | Sc = 390 | samples | | | |
| Ce_{0.0025}Lu_{1.9925}Sc_{0.004}Ca_{0.001}Si_{0.993}O_{4.986} | | | | | |
| Impurities ions: | | | | | |
| 5 ppmW - Ca, Yb,. | | | | | |
| <0.5 ppmW for a Li, Na, K, Cu, Mg, Zn, | | | | | |
| Sr, B, Ga, Ti, Zr, Sn, Hf, La, Pr, Nd, | | | | | |
| Sm, Eu, Tb, Dy, Ho, Er, Tm ions; | | | | | |

For purposes of further illustration and not limitation, the following EXAMPLES disclose still further aspects of the present invention.

### Example 1

A scintillation material having emission maximum in range 400-450 nm and based on a silicate comprising a lutetium (Lu) and cerium (Ce) characterised in that the composition is represented by the chemical formula (Lu_{2-w-x+2y}A_{w}CeₓSi_{1-y})_{1-z}Me_{z}JⱼO_{q} and characterised in that the scintillation material is a crystal. The oxide chemicals (Lu₂O₃, CeO₂, SiO₂) with purity of 99.99% were used for the growing by Czochralski method (CZ) of crystal boule. Content of cerium in top of boule is need about 3×10⁻⁴ f. units. Taking into account, that the segregation coefficient of the cerium ions between a melt and growing crystal is equaled about k=0.2, it is needed to charge a crucible with the starting material having a cerium concentration of 0.0015 f. units.

A CZ growing of crystal was executed from an iridium crucible of the 80 mm in diameter under a good thermal insulation conditions in a protective inert gas atmosphere (100% volume of nitrogen), at pulling rate of 1.2 mm h⁻¹, rotation rate of 10 r.p.m. In these growth conditions the crystals approximately 40 mm in diameter and up to 80 mm length was grown. The polished sample from top (Ce=100 ppmw) was used for measurement parameters and chemical composition (TABLE 1). The crystal composition is Ce_{0.00033}Lu_{2.006}Sc_{0.0032}Si_{0.997}O_{5.008} and the mole ratios of components (Lu+Ce+Sc)/Si=2.026. Concentration of doping ions are Ce=100 ppmw and Sc=340 ppmw. Concentration of impurities ions from raw materials in crystal sample are: <10 ppmw—Cl; <2 ppmW for a Li, Na, K, Al, Ca, Cu, Mg, Zn, Sr, B, Ga, Ti, Zr, Sn, Hf, La, Pr, Nd, Sm, Eu, Tb, Dy, Ho, Er, Tm, Yb ions;

The degradation in optical transmission at 420 nm of crystal sample from top of boule are 15%/cm for Ce⁼¹⁰⁰ ppmw (3×10⁻⁴ f. units) after irradiation by 5*10⁶ rad γ-rays doses.

The crystal composition having chemical formula Ce_{0.00033}Lu_{2.006}Sc_{0.0032}Si_{0.997}O_{5.008} is precisely to equivalent the crystal composition represented by chemical formula Ce_{0.00033}Lu_{1.9965}Sc_{0.0032}Si_{0.9922}O_{4.9844}, because both formulas have the mole ratios of components (Lu+Ce+Sc)/Si=2.026, and for both formulas the calculated percents of the oxides are identical: Lu₂O₃ (86.9 wt. %)+Sc₂O₃ (0.05 wt. %)+CeO₂ (0.01 wt. %)+SiO₂ (13.04 wt. %).

### Example 2

A scintillation material having emission maximum in range 400-450 nm and base on a silicate comprising a lutetium (Lu) and cerium (Ce) characterised in that the composition is represented by the chemical formula (Lu_{2-w-x+2y}A_{w}CeₓSi_{1-y})_{1-z}Me_{z}JⱼO_{q} and characterised in that the scintillation material is a crystal. The oxide chemicals (Lu₂O₃, CeO₂, SiO₂) with purity of 99.99% were used for the growing by Czochralski method (CZ) of crystal boule.

A CZ growing of crystal was executed from iridium crucible in a protective nitrogen gas atmosphere. The polished samples from top and bottom part of boule were used for measurement parameters and chemical compositions (TABLE 1). The crystal composition for top is Ce_{0.00053}Lu_{2.009}Sc_{0.0033}Si_{0.995}O_{5.005} and the mole ratios of components (Lu+Ce+Sc)/Si=2.02. Concentration of doping ions are Ce=165 ppmw (5×10⁻⁴ f. units) and Sc=315 ppmw (3×10⁻³ f. units). Concentration of impurities from raw materials are: 11 ppmw—Cl; 5 ppmw—P; 3 ppmW—Ca; 1.5 ppmW—Yb; <2 ppmW for a Li, Na, K, Al; <0.5 ppmW for a Li, Na, K, Cu, Mg, Zn, Sr, B, Ga, Ti, Zr, Sn, Hf, La, Pr, Nd, Sm, Eu, Th, Dy, Ho, Er, Tm ions. The degradation in optical transmission at 420 nm of crystal sample from top of boule is 7%/cm after irradiation by 5*10⁶ rad γ-rays doses.

The crystal composition having chemical formula Ce_{0.00053}Lu_{2.009}Sc_{0.0033}Si_{0.995}O_{5.009} is precisely to equivalent the crystal composition represented by chemical formula Ce_{0.00033}Lu_{1.9962}Sc_{0.0033}Si_{0.9887}O_{4.9774}, because both formulas have the mole ratios of components (Lu+Ce+Sc)/Si=2.02, and for both formulas the calculated percents of the oxides are identical: Lu₂O₃ (86.93 wt. %)+Sc₂O₃ (0.05 wt. %)+CeO₂ (0.02 wt. %)+SiO₂ (13.00 wt. %).

The crystal composition for bottom is Ce_{0.0013}Lu_{2.02}Sc_{0.003}Si_{0.99}O_{5.012} and the mole ratios of components (Lu+Ce+Sc)/Si=2.044. Concentration of doping ions are Ce=390 ppmw (1.3×10⁻³ f. units) and Sc=290 ppmw (3×10⁻³ f. units). The degradation in optical transmission at 420 nm of crystal sample from bottom of boule is 4/cm after irradiation by 5*10⁶ rad γ-rays doses.

The crystal composition having chemical formula Ce_{0.0013}Lu_{2.02}Sc_{0.003}Si_{0.99}O_{5.012} is precisely to equivalent the crystal composition represented by chemical formula Ce_{0.0013}Lu_{1.9967}Sc_{0.002}Si_{0.9786}O_{4.9572}, because both formulas have the mole ratios of components (Lu+Ce+Sc)/Si=2.044, and for both formulas the calculated percents of the oxides are identical: Lu₂O₃ (87.4 wt. %)+Sc₂O₃ (0.03 wt. %)+CeO₂ (0.05 wt. %)+SiO₂ (12.88 wt. %).

### Example 3

A scintillation material having emission maximum in range 400-450 nm and base on a silicate comprising a lutetium (Lu) and cerium (Ce) characterised in that the composition is represented by the chemical formula (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q}, characterised in that the scintillation material is a ceramic, where J is at least one element selected from the group consisting of N, F, P, S, Cl and j=0.03 f.u.

The chemicals (Lu₂O₃, CeO₂, SiO₂, Y₂O₃, LuCl₃, LuPO₄, LuF₃, Gd₂S₃) with purity of 99.9% were used for the synthesis of the pressed pellets having 8 mm in diameter and 15 mm length. A Ce-doped lutetium-yttrium oxyorthosilicate with the additives of LuCl₃, LuPO₄, LuF₃, Gd₂S₃ was pressed under 2000 atm pressure. After that during the 12 hours the pressed pellets were annealed in a protective inert gas atmosphere at temperature about 1750° C.

The polished 4×4×0.5 mm³ samples from this ceramics were used for comparison of emission intensity at 420 nm, which parameters are presented in TABLE 2. The V-shape schema was used for a direction of excitation and a direction of emission intensity registration. The emission light collected from one 4×4 mm polished surface, the second 4×4 mm polished surface had contact with Al-foil for good reflection of emission light in direction of emission registration, and this direction was perpendicularly to polished surfaces.

In identical experimental conditions were realized the measurements of emission intensity for following ceramic compositions: Ce_{0.01}Lu_{1.91}Y_{0.12}Si_{0.98}O_{5.02}, Ce_{0.01}Lu_{1.83}Y_{0.12}Si_{1.02}O_{4.98}, Ce_{0.01}Lu_{1.92}Y_{0.12}Si_{0.98}F_{0.03}O_{5.02}, Ce_{0.01}Lu_{1.92}Y_{0.12}Si_{0.98}Cl_{0.03}O_{5.02}, Ce_{0.01}Lu_{1.92}Y_{0.12}Gd_{0.02}Si_{0.98}S_{0.03}O_{5.02}, Ce_{0.01}Lu_{1.92}Y_{0.12}Gd_{0.03}Si_{0.98}P_{0.03}O_{5.24}, Ce_{0.01}Lu_{1.83}Y_{0.12}Gd_{0.2}Si_{1.02}S_{0.03}O_{4.98}. The annealing atmosphere and light yield of blue emission are shown in TABLE 2.

This a multi-co-doped oxyorthosilicate ceramics have the high density, high light output, very short lifetime of excited Ce³⁺ ions, therefore this materials are perspective for application in a X-ray systems. In particular, a semiconductors linear arrays for registration of blue light attached to pixels from this ceramics with size about 2×2×2 mm³ it needed for systems with automatically X-ray control of quality using a non-destructive testing of solid state structure, for example, the quality of woods during mass production at plants. In these systems the higher resolution at the product is obtained by the magnification of the X-ray geometry. X-ray magnification is by simple projection, since X-ray source are not refracted by wood materials they encounter, i.e. there are no X-ray lenses. Therefore, if the X-ray source (emission point in the X-ray tube at 5-30 kV, 50 kV, 120 kV, 160 kV) to target distance is for example 15 cm, and the source to detector distance is 30 cm, the magnification is 2x and the pixel resolution at the target is about 1 mm².

One significant result of this invention is that the very fast scintillation (Lu_{2-w-x+2y}A_{w}CeₓSi_{1-y})_{1-z}Me_{z}JⱼO_{q} and (Lu_{2-w-x-2y}A_{w}CeₓSi_{1+y)}_{1-z}Me_{z}JⱼO_{q} materials in form of a ceramic or a crystal are perspective materials x-ray camera for complex imaging applications.

The fast scintillation (Lu_{2-w-x+2y}A_{w}CeₓSi_{1-y})_{1-z}Me_{z}JⱼO_{q} and (Lu_{2-x-2y}A_{w}CeₓSi_{1+y})_{1-z}Me_{z}JⱼO_{q} materials in form of a ceramic or a crystal are a cost effective, safe, high radiation resistance against high energy X-ray (up to 160 kV) irradiation materials for the inspection of trucks and cargo containers for concealed contraband, smuggled goods, and for manifest verification.

A fast scintillation (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} materials in form of a powder or a crystal (having additionally the inclusions with the chemical formula selected from materials of Lu₂Si₂O₇, SiO₂ and Lu₂O₃ with sub-micron size in the range 1-400 nm) or a ceramic are perspective for application in airports during hold baggage screening by X-ray systems.

A fast scintillation (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} materials in form of a crystal (having additionally the inclusions with the chemical formula selected from materials of Lu₂Si₂O₇, SiO₂ and Lu₂O₃ with sub-micron size in the range 1-400 nm) or a ceramic are effective advanced materials for Gamma-ray systems designed to meet the full range of cargo inspection applications. The Gamma-ray systems have an intrinsically lower radiation field when compared to equivalent X-ray systems, the Gamma-ray systems were developed for replacement of X-ray systems. For standard Gamma-ray systems is used the Cesium-137 gamma source, for Enhanced Penetration Gamma-ray systems is used the Cobalt-60 gamma source.

TABLE 2
Comparison of intensity emission at 420 nm.

| | Annealing | Light yield, |
|---|---|---|
| Composition of ceramics | atmosphere | (relative units) |
| Ce_{0.01}Lu_{1.91}Y_{0.12}Si_{0.98}O_{5.02} | 100% nitrogen | 1.00 |
| Ce_{0.01}Lu_{1.83}Y_{0.12}Si_{1.02}O_{4.98} | 100% nitrogen | 0.96 |
| Ce_{0.01}Lu_{1.92}Y_{0.12}Si_{0.98}F_{0.03}O_{5.02} | 100% argon | 1.12 |
| Ce_{0.01}Lu_{1.92}Y_{0.12}Si_{0.98}Cl_{0.03}O_{5.02} | 100% argon | 1.08 |
| Ce_{0.01}Lu_{1.92}Y_{0.12}Gd_{0.02}Si_{0.98}S_{0.03}O_{5.02} | 100% argon | 1.22 |
| Ce_{0.01}Lu_{1.92}Y_{0.12}Gd_{0.03}Si_{0.98}P_{0.03}O_{5.24} | 100% argon | 1.06 |
| Ce_{0.01}Lu_{1.83}Y_{0.12}Gd_{0.02}Si_{1.02}S_{0.03}O_{4.98} | 100% argon | 1.25 |

### Example 4

A CZ growing of crystal was executed from a iridium crucible in a protective inert gas atmosphere (100% volume of argon). During Czochralski growth process the LFS crystal boule has continuous shift of the chemical compositions from top to bottom. A distribution coefficient of yttrium is 0.75; a distribution coefficient of calcium is 0.4; a distribution coefficient of scandium is 1.22, a distribution coefficient of cerium is 0.365. After cutting of grown boule at samples with size 5×5×24 mm, the said samples were annealed in a vacuum at temperature about 1400° C. during 6 hours. At the final stage from this annealed samples was produced polished samples with size 4×4×22 mm. The polished sample was used for measurement of parameters and chemical composition (TABLE 1). The crystal composition for bottom of boule is Ce_{0.0031}Lu_{1.997}Y_{0.0023}Sc_{0.31}Ca_{0.0024}Si_{0.983}O_{5.016} and the mole ratios of components (Lu+Ce+Y+Sc+Ca)/Si=2.071. Concentration of doping ions are Ce=960 ppmw (3.1×10⁻⁴ f. units), Ca=210 ppmw (5.3×10⁻⁴ f. units), Y=440 ppmw (2.3×10⁻³ f. units) and Sc=3050 ppmw (3.1×10⁻² f. units). Concentration of impurities from raw materials are: <5 ppmW for a Li, B, Al, Ti, Zr, Sn, Hf, Ga ions; <10 ppmW for a Na, K, Zn, Sr, La, Pr, Nd, Sm, Eu, Tb, Dy, Ho, Er, Tm ions; <30 ppmW for a Mg, Yb ions.

The transmittance spectrum measured at a spectrophotometer through a 22 mm length of polished sample. The degradation in optical transmission at 420 nm of crystal sample there are not after irradiation up to 23*10⁶ rad γ-rays doses (TABLE 1).

The crystal composition having chemical formula Ce_{0.0031}Lu_{1.997}Y_{0.0023}Sc_{0.031}Ca_{0.0024}Si_{0.983}O_{5.016} is precisely to equivalent the crystal composition represented by chemical formula Ce_{0.0031}Lu_{1.9619}Y_{0.0026}Sc_{0.0305}Ca_{0.0024}Si_{0.9657}O_{4.93}, because both formulas have the mole ratios of components (Lu+Ce+Sc+Y+Ca)/Si=2.071, and for both formulas the calculated percents of the oxides are identical: Lu₂O₃ (86.48 wt. %)+Y₂O₃ (0.06 wt. %)+Sc₂O₃ (0.47 wt. %)+CeO₂ (0.12 wt. %)+CaO (0.03 wt. %)+SiO₂ (12.86 wt. %).

### Example 5

A CZ growing of crystal was executed from an iridium crucible in a protective inert gas atmosphere (99.8% volume of nitrogen+0.2% volume of oxygen). The polished sample from top of boule was used for measurement parameters and chemical composition (TABLE 1).

The crystal composition for top is Ce_{0.00185}Lu_{1.917}Y_{0.110}Si_{0.986}O_{5.014} and the mole ratios of components (Lu+Ce+Y)/Si=2.058. Concentration of doping ions are Ce=560 ppmw (1.85×10⁻³ f. units) and Y=2120 ppmw (1.1×10⁻¹ f. units). Concentration of impurities from raw materials are: 14 ppmw—Yb, 12 ppmw—Ca, 10 ppmw—B, <5 ppmW—Al. Na, K, Cl, S, <1 ppmW for a Pr, Nd, Sm, Eu, Th, Dy, Ho, Er, Tm, La ions;

The degradation in optical transmission at 420 nm of crystal sample from top of boule are 5.2%/cm for Ce=560 ppmw (1.85×10⁻³ f. units) after irradiation by 23*10⁶ rad γ-rays doses.

The crystal composition having chemical formula Ce_{0.00185}Lu_{1.917}Y_{0.110}Si_{0.986}O_{5.015} is precisely equivalent to the crystal composition represented by chemical formula Ce_{0.001852}Lu_{1.8897}Y_{0.108}Si_{0.972}O_{4.943}, because both formulas have the mole ratios of components (Lu+Ce+Y)/Si=2.058, and for both formulas the calculated percents of the oxides are identical: Lu₂O₃ (84.13 wt. %)+Y₂O₃ (2.73 wt. %)+CeO₂ (0.07 wt. %)+SiO₂ (13.07 wt. %).

### Example 6

A CZ growing of crystal was executed from a large iridium crucible in a protective inert gas atmosphere. The crystals approximately 90 mm in diameter and 200 mm length was grown. The polished samples were used for measurement parameters and chemical compositions (TABLE 1). The crystal composition is Ce_{0.0014}Lu_{1.977}Y_{0.037}Ca_{0.001}Si_{0.992}O_{5.007} and the mole ratios of components (Lu+Ce+Y+Ca)/Si=2.033. Concentration of doping ions are Ce=410 ppmw (1.4×10⁻³ f. units), Ca=85 ppmw (1×10⁻³ f. units), Y=8500 ppmw (3.7×10⁻² f. units). Concentration of impurities from raw materials are: 10 ppmw—Yb; 8 ppmw—Na, Cl; <5 ppmW for a Li, Na, Al, K, Cu, Mg, Zn, Sr, B, Ga, Ti, Zr, Sn, Hf, La, Pr, Nd, Sm, Eu, Tb, Dy, Ho, Er, Tm ions. The degradation in optical transmission at 420 nm of crystal sample there are not after irradiation up to 23*10⁶ rad γ-rays doses.

The crystal composition having chemical formula Ce_{0.0014}Lu_{1.977}Y_{0.037}Ca_{0.001}Si_{0.992}O_{5.007} is precisely equivalent to the crystal composition represented by chemical formula Ce_{0.14}Lu_{1.961}Y_{0.037}Ca_{0.001}Si_{0.984}O_{4.967}, because both formulas have the mole ratios of components (Lu+Ce+Y+Ca)/Si=2.033, and for both formulas the calculated percents of the oxides are identical: Lu₂O₃ (85.99 wt. %)+Y₂O₃ (0.91 wt. %)+CeO₂ (0.05 wt. %)+CaO (0.01 wt. %)+SiO₂ (13.03 wt. %).

### Example 7

A CZ growing of crystal was executed from large iridium crucible in a protective nitrogen gas atmosphere. The crystals approximately 95 mm in diameter and up to 200 mm length was grown. The polished samples produced from top part of boule was used for measurement parameters and chemical composition (TABLE 1). The crystal composition is Ce_{0.0007}Lu_{1.996}Sc_{0.0062}Li_{0.00037}Si_{0.998}O_{5.001}. and the mole ratios of components (Lu+Ce+Sc+Li)/Si=2.007. Concentration of doping ions are Ce=210 ppmw (7×10⁻⁴ f. units), Sc=600 ppmw (6.2×10⁻³ f. units), Li=6 ppmw (3.7×10⁻⁴ f. units). Concentration of impurities from raw materials are: 11 ppmw—Yb; 9.5 ppmw—Cl; 3 ppmw—Ca; <2 ppmw Al, Mg, P, S; <1 ppmW for a Na, K, Cu, Zn, Sr, B, Ga, Ti, Zr, Sn, Hf, La, Pr, Nd, Sm, Eu, Tb, Dy, Ho, Er, Tm ions. The degradation in optical transmission at 420 nm of crystal sample from bottom of boule are 4.8%/cm after irradiation by 5*10⁶ rad γ-rays doses.

The crystal composition having chemical formula Ce_{0.0007}Lu_{1.996}Sc_{0.0062}Li_{0.00037}Si_{0.998}O_{5.001} is precisely equivalent to the crystal composition represented by chemical formula Ce_{0.0007}Lu_{1.9927}Sc_{0.0062}Li_{0.00037}Si_{0.996}O_{4.99}, because both formulas have the mole ratios of components (Lu+Ce+Y+Ca)/Si=2.007, and for both formulas the calculated percents of the oxides are identical: Lu₂O₃ (86.78 wt. %)+Sc₂O₃ (0.09 wt. %)+CeO₂ (0.03 wt. %)+SiO₂ (13.10 wt. %).

### Example 8

A scintillation material having emission maximum in range 400-450 nm and base on a silicate comprising a lutetium (Lu) and scandium (Sc) and cerium (Ce) characterised in that the scintillation material is a crystal grown from a melt having the composition represented by the chemical formula (Lu_{2-w-x+2y}A_{w}CeₓSi_{1-y})_{1-z}Me_{z}JⱼO_{q}.

A CZ growing of crystal was executed from a iridium crucible in a protective inert gas atmosphere (100% volume of nitrogen) from melt having composition Ce_{0.002}Li_{0.005}Lu_{2.04}Sc_{0.005}Si_{0.975}O_{5.032} and the mole ratios of components (Lu+Ce+Sc+Li)/Si=2.11. Concentration of impurities in melt from raw materials are: 14 ppmw—Yb; 10 ppmw—Ca; <0.5 ppmW for a Na, K, Cu, Mg, Zn, Sr, B, Ga, Ti, Zr, Sn, Hf, La, Pr, Nd, Sm, Eu, Tb, Dy, Ho, Er, Tm ions. Concentration of doping ions are Ce=540 ppmw (2×10⁻³ f. units), Li=75 ppmw (5×10⁻³ f. units) and Sc=620 ppmw (5×10⁻³ f. units).

After cutting of top part of grown boule at samples, the said samples were annealed in 100% Argon atmosphere at temperature about 1400° C. during 12 hours. At the final stage from this annealed samples it was produced polished samples for measurement of parameters (TABLE 1). The degradation in optical transmission at 420 nm of crystal sample from top of boule are 0.8%/cm after irradiation by 23*10⁶ rad γ-rays doses.

### Example 9

A scintillation material having emission maximum in range 400-450 nm and based on a silicate comprising a lutetium (Lu) and yttrium (Y) cerium (Ce) characterised in that the scintillation material is a crystal grown from a melt having the composition represented by the chemical formula (Lu_{2-w-x+2y}A_{w}CeₓSi_{1-y})_{1-z}Me_{z}JⱼO_{q}.

A CZ growing of crystal was executed from a iridium crucible in a protective inert gas atmosphere (100% volume of argon) from melt having composition Ce_{0.012}Lu_{1.887}Y_{0.12}Si_{0.995}O_{5.004} and the mole ratios of components (Lu+Ce+Y)/Si=2.029. Concentration of impurities in the Lu₂O₃ are: 250 ppmw—Gd; 100 ppmw—Tb; <35 ppmW for a Dy, Ho, Er, Tm; 100 ppmw—Ca, F; 120 ppmw—Si, Cl; 50 ppmw—Fe. Concentration of doping ions in melt are Ce=3700 ppmw (1.2×10⁻² f. units) and Y=23800 ppmw (1.2×10⁻¹ f. units). Produced from bottom part of boule the polished samples were used for measurement of parameters (TABLE 1). The degradation in optical transmission at 420 nm of crystal sample there are not after irradiation up to 45*10⁶ rad γ-rays doses.

### Example 10

A CZ growing of crystal was executed from an iridium crucible in a protective inert gas atmosphere (99.8% volume of nitrogen+0.2% volume of oxygen). After cutting of grown boule at samples with size 5×5×24 mm, the said samples were annealed in a vacuum at temperature about 1400° C. during 6 hours. At the final stage from this annealed samples it was produced polished samples with size 4×4×22 mm. The polished sample used for measurement of parameters and chemical composition (TABLE 1). The crystal composition is Ce_{0.00066}Lu_{1.793}Y_{0.211}Ca_{0.0004}Si_{0.997}O_{5.0014} and the mole ratios of components (Lu+Ce+Y+Ca)/Si=2.011. Concentration of doping ions are Ce=210 ppmw (6.6×10f. units), Ca=35 ppmw (4×10⁻⁴ f. units) and Y=42400 ppmw or 4.24 wt. % (2.1×10⁻¹ f. units). Concentration of impurities from raw materials are: 8 ppmw—Yb, Al, Cl; 6 ppmw—S; <5 ppmW for a Na, K, Cu, Mg, Zn, Sr, B, Ga, Ti, Zr, Sn, Hf, La, Pr, Nd, Sm, Eu, Tb, Dy, Ho, Er, Tm ions. The degradation in optical transmission at 420 nm of annealed in a vacuum the crystal samples are 0.8/dcm after irradiation by 23*10⁶ rad γ-rays doses. The transmittance spectrum measured at a spectrophotometer with a bandwidth of 2 nm through a 22 mm length of sample.

The crystal composition having chemical formula Ce_{0.00066}Lu_{1.793}Y_{0.211}Ca_{0.0004}Si_{0.997}O_{5.0014} is precisely equivalent to the crystal composition represented by chemical formula Ce_{0.00066}Lu_{1.788}Y_{0.211}Ca_{0.0004}Si_{0.995}O_{4.989}, because both formulas have the mole ratios of components (Lu+Ce+Y+Ca)/Si=2.011, and for both formulas the calculated percents of the oxides are identical: Lu₂O₃ (80.96 wt. %)+Y₂O₃ (5.41 wt. %)+CeO₂ (0.03 wt. %)+CaO (0.01 wt. %)+SiO₂ (13.6 wt. %).

### Example 11

A scintillation material having emission maximum in range 400-450 nm and based on a silicate comprising a lutetium (Lu) and cerium (Ce) characterised in that the scintillation material is a crystal grown from a melt having the composition represented by the chemical formula (Lu_{2-w-x+2y}A_{w}CeₓSi_{1-y})_{1-z}Me_{z}JⱼO_{q}.

A CZ growing of crystal was executed from an iridium crucible in a protective inert gas atmosphere (100% volume of argon) from melt having composition Ce_{0.004}Lu_{2.02}Si_{0.99}O_{5.016} and the mole ratios of components (Lu+Ce)/Si=2.044. Concentration of impurities in melt from raw materials are: 1 ppmW—Ca, Yb; <0.5 ppmW for a Li, Na, K, Cu, Mg, Zn, Sr, B, Ga, Ti, Zr, Sn, Hf, La, Pr, Nd, Sm, Eu, Tb, Dy, Ho, Er, Tm ions. Concentration of doping ions in melt are Ce=1230 ppmw (4×10⁻³ f. units) and Mg=180 ppmw (3.4×10⁻³ f. units). The crystals approximately 30 mm in diameter was grown. Produced from bottom part of boule the polished samples were used for measurement of parameters (TABLE 1). The degradation in optical transmission at 420 nm of crystal sample there are not after irradiation up to 45*10⁶ rad γ-rays doses.

### Example 12

A CZ growing of crystal was executed from an iridium crucible of the 40 mm in diameter under a good thermal insulation conditions in a protective inert gas atmosphere (99.8% volume of nitrogen+0.2% volume of oxygen), at pulling rate of 1.5 mm h⁻¹, rotation rate of 10 r.p.m. from melt having composition Ce_{0.02}Lu_{1.244}Gd_{0.715}Zn_{0.02}Si_{0.99}O_{4.97} and the mole ratios of components (Lu+Ce+Gd+Zn)/Si=2.019. Concentration of doping ions in melt are Ce=6400 ppmw (2×10⁻² f. units), Zn=3000 ppmw (2×10⁻¹ f. units), Gd=25500 ppmw or 25.5 wt % (7.15×10⁻¹ f. units). Concentration of impurities in melt from raw materials are: 8 ppmw—Yb; <0.5 ppmW for a Na, K, Cu, Mg, Zn, Sr, B, Ga, Ti, Zr, Sn, Hf, La, Pr, Nd, Sm, Eu, Th, Dy, Ho, Er, Tm ions. In these growth conditions the crystals approximately 12 mm in diameter and 40 mm length was grown. The degradation in optical transmission at 420 nm of crystal sample from top of boule are 8%/cm after irradiation by 5*10⁶ rad γ-rays doses.

### Example 13

A scintillation material having emission maximum in range 400-450 nm and based on a silicate comprising a lutetium (Lu) and scandium (Sc) and cerium (Ce) and characterised in that the scintillation material is a crystal grown from a melt having the composition represented by the chemical formula (Lu_{2-w-x-2y}A_{w}CeₓSi_{1+y})_{1-z}Me_{z}JⱼO_{q}

A CZ growing of crystal was executed from an iridium crucible in a protective inert gas atmosphere (100% volume of argon) from melt having composition Ce_{0.002}Li_{0.002}Lu_{1.983}Sc_{0.005}Si_{1.004}O_{4.994} and the mole ratios of components (Lu+Ce+Sc+Li)/Si=1.984. Concentration of impurities in melt from raw materials are: 35 ppmw—Ca; 9 ppmw—Yb; <0.5 ppmW for a Na, K, Cu, Mg, Zn, Sr, B, Ga, Ti, Zr, Sn, Hf, La, Pr, Nd, Sm, Eu, Tb, Dy, Ho, Er, Tm ions. Concentration of doping ions are Ce=600 ppmw (2×10⁻³ f. units), Li=30 ppmw (2×10⁻³ f. units) and Sc=500 ppmw (5×10⁻³ f. units). The crystal approximately 40 mm in diameter and 100 mm length was grown. Produced from top part of boule the polished samples were used for measurement parameters (TABLE 1).

This example is an experimental support for the fourth task of the given invention: a creation of advanced (Lu_{2-w-x-2y}A_{w}CeₓSi_{1+y})_{1-z}Me_{z}JⱼO scintillation materials having the total silicon concentration from Si_{1.00l} till Si_{1.04} and the mole ratios of components (Lu_{2-w-x-2y}+Ceₓ+A_{w})/Si_{1+y}<2; the high density ˜6.8-7.4 g/cm³; the high light output about 60-95% of NaI(Tl); the one exponential decay constant in the range 12-38 ns; the maximum emission of light in the range 400-450 nm; and the high radiation resistance against gamma-rays irradiation.

### Example 14

A CZ growing of crystal was executed from an iridium crucible in a protective inert gas atmosphere (100% volume of argon). The melt composition is Ce_{0.0025}Lu_{2.00}Sc_{0.004}Ca_{0.001}Si_{0.997}O_{5.005} and the mole ratios of components (Lu+Ce+Sc+Ca)/Si=2.0135. Concentration of doping ions are Ce=770 ppmw (2.5×10⁻³ f. units), Ca=90 ppmw (1×10⁻³ f. units) and Sc=390 ppmw (4×10⁻³ f. units). Concentration of impurities from raw materials are: 5 ppmW for a Ca, Yb, <0.5 ppmW for a Li, Na, K, Cu, Mg, Zn, Sr, B, Ga, Ti, Zr, Sn, Hf, La, Pr, Nd, Sm, Eu, Th, Dy, Ho, Er, Tm ions;

After cutting of bottom part of grown boule at samples, the said samples were annealed in a vacuum at temperature about 1450° C. during 24 hours. At the final stage from this annealed samples it was produced the polished samples for measurement of parameters (TABLE 1). The degradation in optical transmission at 420 nm of crystal sample there are not after irradiation up to 23*10⁶ rad γ-rays doses.

The melt composition having chemical formula Ce_{0.0025}Lu_{2.00}Sc_{0.004}Ca_{0.001}Si_{0.997}O_{5.005} is precisely equivalent to the melt composition represented by chemical formula Ce_{0.0025}Lu_{1.9925}Sc_{0.004}Ca_{0.001}Si_{0.993}O_{4.986}, because both formulas have the mole ratios of components (Lu+Ce+Sc)/Si=2.0135, and for both formulas the calculated percents of the oxides are identical: Lu₂O₃ (86.77 wt. %)+Sc₂O₃ (0.06 wt. %)+CeO₂ (0.09 wt. %)+CaO (0.01 wt. %)+SiO₂ (13.06 wt. %).

This example is an experimental support for the third task of the given invention: a creation of advanced (Lu_{2-w-x+2y}A_{w}CeₓSi_{1-y})_{1-z}Me_{z}JⱼO_{q} scintillation crystals having the mole ratios of components (Lu_{2-w-x+2y}+Ceₓ+A_{w})/Si_{1-y}>2; the high density ˜6.8-7.4 g/cm³; the high light output about 60-95% of NaI(Tl); the one exponential decay constant in the range 12-38 ns; the maximum emission of light in the range 400-450 nm; no degradation in optical transmission after gamma-rays irradiation with the dose up to 23 Mrad.

### Example 15

A fast scintillation (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} materials in form of a crystal, in which said crystal has high radiation hardness and no degradation reduction in optical transmission in the range 400-450 nm after irradiation by high-energy protons of 155 MeV/c protons with fluency 4×10¹² cm⁻².

From crystal boules have been cut up to the samples with the dimensions of 11×11 mm² and 20 mm long. All crystals samples have been polished to an optical grade. The crystals were packed to 3×2 matrix for simultaneous irradiation with proton beam from proton synchrotron. The proton beam with diameter about 50 mm was parallel to long size of 3×2 crystal matrix. The beam uniformity was lower than 5% over the whole beam spot. All crystals have been irradiated to a 155 MeV/c protons up to fluence of 4.4×10¹² p/cm². Optical transmission spectra across a 20 mm thickness were measured with a spectrophotometer before and at various intervals after proton irradiation. Due to induced radioactivity of LFS crystals first measurements of optical transmission of crystals samples were made in 30 days after proton irradiation.

A crystal having composition Ce_{0.0014}Lu_{1.977}Y_{0.037}Ca_{0.001}Si_{0.992}O_{5.007} and a crystal grown from melt Ce_{0.012}Lu_{1.928}Y_{0.12}Si_{0.97}O_{5.03} was used for investigation proton induced damage.

A CZ grown crystal from Ce_{0.012}Lu_{1.928}Y_{0.12}Si_{0.97}O_{5.03} melt composition, having the concentration of impurities in melt from raw materials: 27 ppmw—Yb; 35 ppmw—Ca; <30 ppmW for a Li, B, Al, Ti, V, Cr, Mn, Co, Ni, Ge, Zr, Sn, Hf, Na, K, Cu, Ag, Zn, Sr, Cd, Fe, Pr, Nd, Sm, Eu, Tb, Dy, Ho, Er, Tm; <50 ppmW for the N, F, P, Cl, S, Mg, Ga, La ions was investigated. Concentration of doping ions in melt are Ce=3700 ppmw (1.2×10⁻² f. units) and Y=23300 ppmw (1.2×10⁻¹ f. units). The said crystal has high radiation hardness and no degradation reduction in optical transmission in the range 400-450 nm after irradiation by high-energy protons of 155 MeV/c protons with fluency 4×10¹² cm⁻².

A CZ grown Ce_{0.0014}Lu_{1.977}Y_{0.037}Ca_{0.001}Si_{0.992}O_{5.007} crystal has concentration of doping ions: Ce=410 ppmw (1.4×10⁻³ f. units), Ca=85 ppmw (1×10⁻³ f. units), Y=8500 ppmw (3.7×10⁻² f. units). Concentration of impurities from raw materials are: 10 ppmw—Yb; 8 ppmw—Na, Cl; <5 ppmW for a Li, Na, Al, K, Cu, Mg, Zn, Sr, B, Ga, Ti, Zr, Sn, Hf, La, Pr, Nd, Sm, Eu, Tb, Dy, Ho, Er, Tm ions.

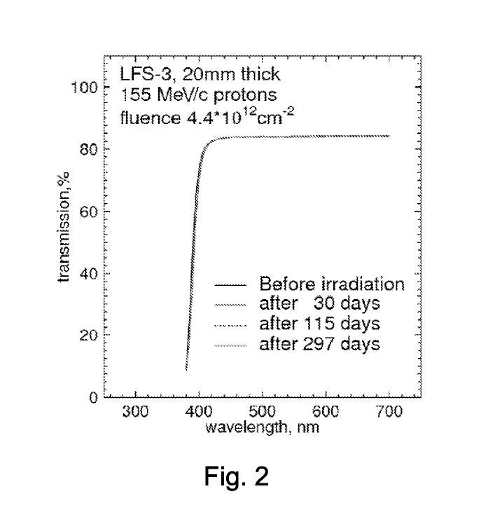

The transmission spectra for Ce_{0.0014}Lu_{1.977}Y_{0.037}Ca_{0.001}Si_{0.992}O_{5.007} (LFS-3) crystal are presented in FIG. 2. The LFS-3 crystal has high radiation hardness and no degradation reduction in optical transmission in the range 400-450 nm after irradiation by high-energy protons of 155 MeV/c protons with fluency 4×10¹² cm⁻².

### Example 16

The Light Yield (ph/MeV) and energy resolution (%) of a fast scintillation (Lu_{2-w-x+2y}A_{w}CeₓSi_{1-y})_{1-z}Me_{z}JⱼO_{q} and (Lu_{2-w-x-2y}A_{w}CeₓSi_{1+y})_{1-z}Me_{z}JⱼO_{q} materials in form of a crystal are important for PET scanners. Prior to measurement of the energy resolution, the samples were stored in the dark for at least 24 h to eliminate the thermoluminescence emission that is stored upon exposure to white light. Light collection was carried out by placing the crystal directly onto a Hamamatsu R4125Q photomultiplier tube (with quartz window); a fast amplifier ORTEC 579 and a charge-sensitive height converter ADC LeCroy 2249W were used. The crystal samples were covered with a Teflon tape and an Al foil to enhance the light collection efficiency. A Cs¹³⁷ source was located 15 mm from the crystal surface. The natural background spectrum from the Lu¹⁷⁶ beta decay was minimal due to the small samples size and was not subtracted. In order to extract the photoelectron yield and light output of scintillators, the position of the full energy peak from ¹³⁷Cs source was compared with that of the single photoelectron peak.

The sizes samples were 4×4×22 mm (6 sides polished) in Positron Emission Tomography (PET) scanners for the whole-body imaging during diagnostic at early stage cancer of a patient in hospitals. In case of the neuro-imaging of human brain the sizes samples are 3×3×10 mm3 or 3×3×15 mm3 mm (6 sides polished).

A crystal having composition Ce_{0.0014}Lu_{1.977}Y_{0.0037}Ca_{0.001}Si_{0.992}O_{5.007} was used for production pixels with size 4×4×22 mm³ (6 side polished), 3×3×10 mm³ (6 side polished) and the 6 side polished plates with cross section 8×8 mm² and thickness 1 mm. This crystal have concentration of doping ions: Ce=410 ppmw (1.4×10⁻³ f. units), Ca=85 ppmw (1×10⁻³ f. units), Y=8500 ppmw (3.7×10⁻² f. units). Concentration of impurities from raw materials are: 10 ppmw—Yb; 8 ppmw—Na, Cl; <5 ppmW for a Li, Na, Al, K, Cu, Mg, Zn, Sr, B, Ga, Ti, Zr, Sn, Hf, La, Pr, Nd, Sm, Eu, Th, Dy, Ho, Er, Tm ions.

The crystal 4×4×22 mm³ pixel covered with Teflon reflector and additionally with Al foil reflector from 5 surfaces and the open 4×4 mm² surface was placed directly on the Hamamatsu R4125Q photomultiplier. For minimal loss of the emission light and good optical contact between 4×4 mm² pixel surface and window of photomultiplier a standard fluid material from high-energy physics was used. The energy resolution for the full energy peak with the energy resolution (FWHM) from 8.0% till 8.8% for 5 investigated pixels was measured. The said pixels were annealed in gas atmosphere 80% volume of argon+20% volume of CO₂ at temperature about 1400° C.

For minimization the influence of the light collection processes, and allowed to characterize the quality of the Ce_{0.0014}Lu_{1.977}Y_{0.037}Ca_{0.001}Si_{0.992}O_{5.007} crystal it was tested a 3×3×10 mm³ pixel for two variants of attached by (i) 3×10 mm² and by (ii) 3×3 mm² face to the PMT. The energy resolution for the full energy peak with the energy resolution (FWHM) was measured 6.7% for (i) and 7.0% for (ii) experiments. The orientation 3×3 mm² face to the PMT is used in the PET scanners for the neuro-imaging of human brain, for this orientation and 5 measured pixels the light output was about 41000 ph/MeV. The said pixels were annealed in gas atmosphere 100% volume of argon at temperature about 1400° C.

The better parameters it was registry for 8×8×1 mm³ plate covered at the 5 surfaces by Teflon reflector with additionally Al foil reflector. The open 8×8 mm² surface was placed directly on the Hamamatsu R4125Q photomultiplier with a standard fluid material for minimization optical losses. This polished plate shown the light output of 42100 ph/MeV and energy resolution 6.3%.

### Example 17

A method of production of a scintillation cerium doped lutetium-based oxyorthosilicate including LFS, LSO, LYSO, LGSO crystals having the decay time in the range 12-30 ns, and said method is annealing of a crystal samples in vacuum or 100% Argon atmosphere at temperature about 1400-1600° C. during time about 6-24 hours.

For example, to obtain the LYSO crystal from melt having composition Ce_{0.002}Lu_{1.798}Y_{0.2}S_{1.000}O_{5.000}, the following method of making of the samples was used: the chemicals of lutetium oxide, yttrium oxide, cerium oxide and silicon oxide in the quantities determined by the mole ratio of components (Lu+Y+Ce)/Si=2.000 were thoroughly mixed, pressed in pellets and synthesised in a platinum crucible during 24 hours at 1250° C. Then by means of induction heating the pellets were melted in an iridium crucible in a hermetically sealed chamber in protective nitrogen atmosphere (99.7% volume of nitrogen with 0.3% volume of oxygen). The LYSO crystal was grown by Czochralski method. After cutting of grown LYSO boule at samples, a part of said samples were annealed in a vacuum at temperature about 1450° C. during 12 hours. At the final stage from this annealed samples was produced polished samples. The annealed in a vacuum LYSO samples demonstrated decay time in the range 30-32 ns, in comparison with decay time in the range 41-44 ns of LYSO samples after growth in atmosphere of 99.7% volume of nitrogen with 0.3% volume of oxygen.

For example, the oxide chemicals (Lu₂O₃, CeO₂, Gd₂O₃, SiO₂) were used for the growing by Czochralski method of cerium doped lutetium-gadolinium oxyorthosilicate CeₓLu_{2-x-y}Gd_{y}SiO₅ (LGSO). The crystal growth was executed from an iridium crucible containing the melt characterised by the mole ratio of components (Lu+Ce+Gd)/Si=2.000. Crystallization was executed in a protective nitrogen atmosphere (99.8% volume of nitrogen with 0.2% volume of oxygen). The grown LGSO crystal had a high optical quality and did not comprise the fine scattering inclusions. After cutting of grown boule at samples, a one part of samples were annealed in 100% Argon atmosphere at temperature about 1600° C. during 12 hours. The second part of samples were annealed in vacuum at temperature about 1400° C. during 12 hours. At the final stage from this annealed samples was produced polished samples.

The annealed in a vacuum LGSO samples and annealed in 100% Argon atmosphere LGSO samples characterised in that the decay times are shorter in both case in comparison of samples grown in atmosphere of 99.8% volume of nitrogen with 0.2% volume of oxygen.

The annealed in a vacuum LFS, LSO, LYSO, LGSO crystal samples showed important technical result of this invention—a method of production of scintillation cerium doped lutetium-based oxyorthosilicate materials (crystals/ceramics) having short decay time about 12-30 ns.

### Example 18

A method of production of a scintillation cerium doped lutetium-based oxyorthosilicate including LFS, LSO, LYSO, LGSO crystals having hard radiation hardness, the said radiation hardness it is mean no-degradation in optical transmission in the range 400-450 nm after irradiation by gamma ray with the dose in the range 5-23 Mrad, and method is annealing of a said crystal samples in vacuum or 100% Argon atmosphere at temperature about 1400° C.

The oxide chemicals (Lu₂O₃, CeO₂, SiO₂) with purity of 99.995% were used for the growing by Czochralski method of cerium doped lutetium oxyorthosilicate Ce₂ₓLu₂₍₁₋ₓ₎SiO₅ (LSO). The crystal growth was executed from an iridium crucible containing the melt characterised by the composition of Ce_{0.002}Lu_{1.998}S_{1.000}O_{5.000} and the mole ratio of components (Lu+Ce)/Si=2.000.

Crystallization was executed in a protective nitrogen atmosphere (99.8% volume of nitrogen with 0.2% volume of oxygen). The grown LSO crystal had a high optical quality and did not comprise the fine scattering inclusions. After cutting of grown boule at samples with size 5×5×24 mm, the said samples were annealed in a vacuum at temperature about 1400° C. during 12 hours. At the final stage from this annealed samples was produced polished samples with size 4×4×22 mm. The polished sample was used for measurement of radiation hardness after irradiation by gamma ray. The degradation in optical transmission at 420 nm of crystal sample there are not after irradiation up to 5*10⁶ rad γ-rays doses.

While the foregoing description represent the certain embodiments of the present invention, it will be understood that various additions and/or substitutions may be made therein without departing from the spirit and scope of the present invention. One skilled in the art will appreciate that the invention may be used with many modifications of structure, forms, arrangement, proportions, materials, and components and otherwise, used in the practice of the invention and which are particularly adapted to specific environments and operative requirements, without departing from the principles of the present invention. The presently disclosed embodiments are therefore to be considered in all respects as illustrative and not restrictive.

What is claimed is:

1. A scintillation material having an emission maximum in the range of about 400-450 nm and based on a silicate comprising lutetium (Lu) and cerium (Ce) characterised in that the composition is represented by one of the two chemical formulas
(Lu_{2-w-x+2y}A_{w}CeₓSi_{1-y})_{1-z}Me_{z}JⱼO_{q} (1)
where:
A is at least one element selected from the group consisting of Sc, Y, Gd, and Lu;
Me is at least one element selected from the group consisting of Li, Na, K, Cu, Ag, Mg, Ca, Zn, Sr, Cd, B, Al, Ga, V, Cr, Mn, Fe, Co, Ni, Ti, Ge, Zr, Sn, Hf, La, Pr, Nd, Sm, Eu, Tb, Dy, Ho, Er, Tm, Yb, and Lu;
J is at least one element selected from the group consisting of N, F, P, S, and Cl;
q is a value between 4.9 f.u. and 5.024 f.u.,
w is a value between near 0 f.u. and 1f.u.,
x is a value between 3×10⁻⁴ f.u. and 0.02 f.u.,
y is a value between 0.003 f.u. and 0.024 f.u.,
z is a value between near 0 f.u. and 0.001f.u., and
j is a value between near 0 f.u. and 0.03 f.u.,
(Lu_{2-w-x-2y}A_{w}CeₓSi_{1+y})_{1-z}Me_{z}JⱼO_{q} (2)
where:
A is at least one element selected from the group consisting of Sc, Y, Gd, and Lu;
Me is at least one element selected from the group consisting of Li, Na, K, Cu, Ag, Mg, Ca, Zn, Sr, Cd, B, Al, Ga, V, Cr, Mn, Fe, Co, Ni, Ti, Ge, Zr, Sn, Hf, La, Pr, Nd, Sm, Eu, Tb, Dy, Ho, Er, Tm, Yb, and Lu;
J is at least one element selected from the group consisting of N, F, P, S, and Cl;
q is a value between 4.9 f.u. and 5.0 f.u.,
w is a value between near 0 f.u. and 1f.u.,
x is a value between 3×10⁻⁴ f.u. and 0.02 f.u.,
y is a value between 0.001f.u. and 0.04 f.u.,
z is a value between near 0 f.u. and 0.001f.u., and
j is a value between near 0 f.u. and 0.03 f.u.,

2. The scintillation material of claim 1, further characterised in that the scintillation material is a crystal.

3. The scintillation material of claim 1, further characterised in that the scintillation material is a crystal having inclusions selected from Lu₂Si₂O₇, SiO₂ or Lu₂O₃ with a sub-micron size in the range of 1-400 nm and in a quantity not exceeding 0.5 wt % of the scintillation material.

4. The scintillation material of claim 1, further characterised in that the scintillation material is a ceramic.

5. The scintillation crystal of claim 1, wherein the cerium (Ce) content is in the range of 100-3100 ppmW and the calcium (Ca) content is in the range 5-600 ppmW.

6. The scintillation material of claim 1, wherein
Me is in a quantity not exceeding 10 ppmW for the Li, B, Al, Ti, V, Cr, Mn, Co, Ni, Ge, Zr, Sn, and Hf ions;
less than 30 ppmW for the Na, K, Cu, Ag, Zn, Sr, Cd, Fe, Pr, Nd, Sm, Eu, Tb, Dy, Ho, Er, Tm, and Yb ions;
less than 100 ppmW for the Mg, Ga, and La ions;
in the range of 1-600 ppmW for the Ca ions;
less than 50 ppmW for the N, F, Cl, and S ions; and
less than 100 ppmW for P ions.

7. The scintillation material of claim 1, wherein the cerium (Ce) content is in the range of 100-3100 ppmW, the calcium (Ca) content is in the range of 1-600 ppmW, and the scandium (Sc) content is in the range of near 0-20000 ppmW.

8. The scintillation material of claim 1, wherein the cerium (Ce) content is in the range of 100-3100 ppmW, the calcium (Ca) content is in the range of 1-600 ppmW, the scandium (Sc) content is in the range of near 0-20000 ppmW, and the yttrium (Y) content is in the range of near 0-60000 ppmW (6 wt. %).

9. The scintillation material of claim 1, wherein the cerium (Ce) content is in the range of 100-6400 ppmW, the calcium (Ca) content is in the range of 1-600 ppmW, the scandium (Sc) content is in the range of near 0-20000 ppmW, and the gadolinium (Gd) content is in the range of near 0-356000 ppmW (35.6 wt. %)

10. The scintillation material of claim 1 wherein the decay time is in the range of 12-45 ns for application in TOF PET and DOI PET scanners.

11. The scintillation material of claim 1 wherein the decay time is in the range of 12-35 ns for detection of elementary particles and nuclei in high-energy physics.

12. The scintillation material of claim 1 wherein the light output is in the range of 35000-41000 ph/Mew.

13. The scintillation material of claim 1 wherein the light output is in the range of 20000-38000 ph/Mew.

14. The scintillation material of claim 1 wherein the density is in the range of 6.8-7.42 g/cm³.

62

15. The scintillation material of claim 1 in the form of a crystal, wherein said crystal has high radiation hardness and no degradation in optical transmission in the range of 400-450 nm after irradiation by gamma ray with the dose of up to 23 Mrad.

16. The scintillation material of claim 1 in the form of a crystal, wherein said crystal has high radiation hardness and no degradation reduction in optical transmission in the range of 400-450 nm after irradiation by high-energy protons of 155 MeV/c protons with fluency of 4×10¹² cm⁻².

17. The scintillation material of claim 1 wherein the decay time is in the range of about 12-35 ns.

18. A cerium-activated lutetium-based oxyorthosilicate scintillation crystal having an emission maximum in the range of 400-450 nm and having scandium (Sc) in an amount greater than about 50 ppmW.

19. The cerium-activated lutetium-based oxyorthosilicate scintillation crystal of claim 18, further comprising calcium (Ca) in an amount greater than about 15 ppmW.

20. A cerium-activated lutetium-based oxyorthosilicate scintillation crystal having an emission maximum in the range of about 400-450 nm, a decay time in the range of about 12-32 ns, and characterised in that said crystal is comprised of the chemical elements:
matrixes (major) elements: silicon (Si), oxygen (O), and lutetium (Lu);
doping elements: cerium (Ce) in an amount ranging from about 100-3100 ppmW and calcium (Ca) in an amount ranging from about 5-600 ppmW;
impurity elements: in a quantity not exceeding 10 ppmW for the Li, B, Al, Ti, V, Cr, Mn, Co, Ni, Ge, Zr, Sn, and Hf ions;
less than 30 ppmW for the Na, K, Cu, Ag, Zn, Sr, Cd, Fe, Pr, Nd, Sm, Eu, Tb, Dy, Ho, Er, Tm, and Yb ions;
less than 100 ppmW for the Mg, Ga, and La ions;
less than 50 ppmW for the F, Cl, and S ions; and
less than 100 ppmW for P ions.

21. A scintillation lutetium based oxyorthosilicate crystal having an emission maximum in the range of about 400-450 nm, having a decay time in the range of about 12-32 ns, having a density in the range of about 6.8-7.42 g/cm³, and comprising lutetium (Lu) and cerium (Ce) and characterised in that said crystal is comprised of chemical elements:
matrixes (major) elements: silicon (Si), oxygen (O), lutetium (Lu), and at least one element selected from the group consisting of scandium (Sc), yttrium (Y), and gadolinium (Gd);
doping elements: cerium (Ce) in an amount ranging from about 100-3100 ppmW and calcium (Ca) in an amount ranging from about 5-600 ppmW;
impurity elements: in a quantity not exceeding 10 ppmW for the Li, B, Al, Ti, V, Cr, Mn, Co, Ni, Ge, Zr, Sn, and Hf ions;
less than 30 ppmW for the Na, K, Cu, Ag, Zn, Sr, Cd, Fe, Pr, Nd, Sm, Eu, Tb, Dy, Ho, Er, Tm, and Yb ions;
less than 100 ppmW for the Mg, Ga, and La ions;
less than 50 ppmW for the F, Cl, and S ions; and
less than 100 ppmW for P ions.

22. A large single crystal boule of cerium-activated lutetium-based oxyorthosilicate made from an off-stoichiometric melt of starting oxides, wherein the starting oxides have a purity of about 99.9% and include at least cerium oxide, lutetium oxide, and silicon oxide, and wherein at least 50% of the melt becomes part of the large crystal boule.

23. A scintillation lutetium-based oxyorthosilicate crystal having an emission maximum in the range of about 400-450 nm, having a decay time in the range of about 12-32 ns, and wherein after irradiation of said crystal by gamma rays of a dose in the range of 5-23 Mrad there is no degradation of optical transmission in the range of 400-450 nm.

24. A scintillation lutetium-based oxyorthosilicate crystal having emission maximum in range of 400-450 nm and having a decay time in the range of 12-32 ns.

25. A method of making a scintillation cerium doped lutetium based oxyorthosilicate including LFS, LSO, LYSO, LGSO crystals having a decay time in the range of 12-30 ns, wherein said method comprises at least the steps of:
growing a boule of said crystal;
cutting the boule into a plurality of crystal samples; and
annealing the plurality of crystal samples in a vacuum or a 100% Argon atmosphere at a temperature of about 1400-1600° C. for a period time of about 6-24 hours.

26. A method of making a scintillation cerium doped lutetium based oxyorthosilicate including LFS, LSO, LYSO, LGSO crystals, wherein after irradiation of said crystal by gamma rays of a dose in the range of 5-23 Mrad there is no degradation of optical transmission in the range of 400-450 nm, and wherein said method comprises at least the steps of:
growing a boule of said crystal;
cutting the boule into a plurality of crystal samples; and
annealing the plurality of crystal samples in a vacuum or a 100% Argon atmosphere at temperature of about 1400° C.

27. The method of making a scintillation cerium doped lutetium based oxyorthosilicate in accordance with claim 27, wherein the step of annealing is for a duration of time of about 6-24 hours.

28. The method of making a scintillation cerium doped lutetium based oxyorthosilicate in accordance with claim 26, wherein the plurality of crystal samples each have approximately cross-sectional dimensions ranging from about 3×3 mm till 25×25 mm and a thickness ranging from about 2 mm till 25 mm.

29. A scintillation cerium doped lutetium based oxyorthosilicate including LFS, LSO, LYSO, LGSO crystal samples having enhanced radiation hardness in that there is no degradation in optical transmission in the range of 400-450 nm after irradiation by gamma rays with a dose in the range of 5-23 Mrad, wherein said crystal samples have a calcium (Ca) concentration ranging from approximately 5 ppmw till 400 ppmw, and a magnesium (Mg) concentration ranging from approximately 0 ppmw till 200 ppmw, and a cerium (Ce) concentration ranging from approximately 150 ppmw till 600 ppmw.

30. A method of making a scintillation cerium doped lutetium based oxyorthosilicate including LFS, LSO, LYSO, LGSO crystals having an energy resolution for the full energy peak in the range from 6% till 10%, wherein said method comprises at least the steps of:
growing a boule of said crystal;
cutting the boule into a plurality of crystal samples; and
annealing of the plurality of crystal samples in a vacuum or a gas atmosphere of about 80-100% volume of argon plus about 0-20% volume of CO₂ and at temperature of about 1400-1600° C. and for a duration of time of about 6-24 hours.
